(19) United States
(12) Patent Application Publication
(10) Pub. No.: US 2024/0404808 A1
(43) Pub. Date: Dec. 5, 2024

(54) AUTOMATIC GAIN CONTROL

(71) Applicant: Thermo Fisher Scientific (Bremen) GmbH, Bremen (DE)

(72) Inventors: Hamish Stewart, Bremen (DE); Immo Colonius, Bremen (DE); Arne Kreutzmann, Bremen (DE); Johannes Petzoldt, Bremen (DE); Max Hoek, Bremen (DE); Andreas Kühn, Bremen (DE); Amelia Corinne Peterson, Bremen (DE); Christian Hock, Bremen (DE); Bastien Reitmeier, Bremen (DE)

(73) Assignee: Thermo Fisher Scientific (Bremen) GmbH, Bremen (DE)

(21) Appl. No.: 18/677,292

(22) Filed: May 29, 2024

(30) Foreign Application Priority Data
May 30, 2023 (GB) 2308045.0

(51) Int. Cl. H01J 49/00; H01J 49/40

(52) U.S. Cl. CPC H01J 49/0031; H01J 49/406

(57) ABSTRACT

A first analytical instrument is configured to be controlled according to one or more first operating parameters; and controlling the configured first analytical instrument based on an estimated ion current obtained by: selecting at least one signal from stored data comprising a plurality of signals and a respective one or more second operating parameters associated with each of the plurality of signals, wherein each signal of the plurality of signals is representative of an ion current obtained using the first analytical instrument configured according to the respective associated one or more second operating parameters or using a second analytical instrument configured according to the respective associated one or more second operating parameters, and wherein the at least one signal is selected based on the one or more first operating parameters; and using the at least one selected signal to estimate the ion current.

### CROSS REFERENCE TO RELATED APPLICATION

This application claims priority from application GB 2308045.0, filed May 30, 2023. The entire disclosure of application GB 2308045.0 is incorporated herein by reference.

### FIELD

The disclosure relates generally to the field of mass spectrometry. More particularly, the disclosure relates to a method of controlling an analytical instrument and a system comprising an analytical instrument and a database.

### BACKGROUND

All mass spectrometers suffer some limitation in their dynamic range (their ability to process and measure different, especially large, amounts of sample material). The limitations may depend on various factors. For example, intense peaks analysed within an orbital trapping mass analyser may create signal artifacts (known as Gibb's oscillations) that interfere with detection of low-lying peaks. Ion detectors (for example, multi-channel plates) may be restricted in the amount of current they can supply to amplify ion signals. An issue common to many mass spectrometers is the influence of space charge, where mutual repulsion forces between large numbers of ions overwhelm the directed forces applied by an analyser.

Many mass and/or ion mobility analysers (for example, time-of-flight, Fourier Transform ion cyclotron resonance, ion traps and orbital trapping mass analysers) operate in a pulsed fashion, accumulating ions from a continuous source prior to analysis. Due to this concentration of ions, the analysers are particularly vulnerable to the effects of space charge. Ion traps for example have a limited trapping capacity, and rapidly lose trapping efficiency for high or low mass-to-charge ratio (m/z) ions when overfilled. Ion detectors saturate quickly due to the simultaneous arrival of thousands of ions. Orbital trapping mass analysers typically suffer a global m/z shift as a consequence of a high number of trapped charges. It is therefore important to estimate how many ions are present in each accumulation region of an ion analytical instrument.

Additionally, the accumulation times required for useful mass spectra may vary greatly. For instance, around 5000 ions may be targeted for probable identification of a peptide fragmentation spectrum. Accurately determining an accumulation time is important for ion-based analytical instruments. Too short an accumulation time may result in underfill, leading to a wasted spectrum. On the other hand, too great an accumulation time, beyond the space charge related issues, may exceed the analyser repetition rate and bottleneck the rate at which different analytes may be studied. Thus, accurately estimating the accumulation time (or the number of ions) is important.

In view of these issues, control of the analysed ion population based on an estimation of the incoming ion current, often termed “automatic gain control” or AGC, is commonly implemented in analytical instruments. An early form of AGC was described in U.S. Pat. No. 5,107,109 A for ion traps, although the method has since been extended to other elements of analytical instruments (for example, accumulating devices that inject into a downstream mass analyser). U.S. Pat. No. 5,107,109 A describes making a first measurement of ion current and using the first measurement to control the ion accumulation time prior to an analytical measurement. This initial measurement is often called a pre-scan, where it is specifically made for the purpose of ion current measurement. However, a pre-scan may also refer to a preceding scan in a method involving a series of mass scans. Whilst the space charge limitation may be understood in terms of ion intensity, methods have been developed to calibrate ion detectors and accurately determine real ion populations (for example, as described in U.S. Pat. No. 7,109,474 B2).

The methods described in these documents are intended for implementing a single automatic gain control method on a single instrument. It would be desirable to implement more than one automatic gain control method and apply automatic gain control methods across different instruments.

### SUMMARY

Against this background, there is provided a method of operating an analytical instrument, and an analytical instrument. Additional aspects appear in the description and claims.

In accordance with a first aspect, there is a method of controlling a first analytical instrument, the method comprising:
configuring the first analytical instrument to be controlled according to one or more first operating parameters; and
controlling the configured first analytical instrument based on an estimated ion current, wherein the ion current is estimated by:
   selecting at least one signal from stored data comprising a plurality of signals and a respective one or more second operating parameters associated with each of the plurality of signals, wherein each signal of the plurality of signals is representative of an ion current obtained using the first analytical instrument configured according to the respective associated one or more second operating parameters or using a second analytical instrument configured according to the respective associated one or more second operating parameters, and wherein the at least one signal is selected based on the one or more first operating parameters; and
   using the at least one selected signal to estimate the ion current.

The method may enable an ion current to be estimated more accurately, as information relating to, for example, various scan types, mass analysers, mass-to-charge windows and so on, can be obtained, rather than relying only on the most recent information for the first analytical instrument. Thus, the method may enable an optimal automatic gain control strategy to be determined based on the most appropriate data. This may be, for example, the most similar previous scan in the stored data. Automatic gain control may be implemented in various types of analytical instrument to, for example, prevent or reduce space charge effects or saturation. For instance, automatic gain control may be implemented in a mass spectrometer, an ion mobility spectrometer, an ion detector or ion spectroscopy applications. Improving the automatic gain control may in turn improve the accuracy of results obtained by the first analytical instrument.

The method may also enable switching between various automatic gain control strategies (and this may be achieved extemporaneously), as the information may be used to determine that the optimal automatic gain control strategy has changed. For example, more up-to-date information may indicate a sudden signal shift, such that a previously implemented automatic gain control strategy would result in less accurate ion current estimation and gain control.

Furthermore, the disadvantages of certain scan types can be overcome and/or the advantages of various scan types can be taken into account, since more than one signal can be used to estimate an ion current. The method may thus provide a more universal method for ion current estimation.

The method may also allow automatic gain control for more complex analytical methods (for example, hybrid methods) to be provided in a straightforward manner.

Furthermore, the method may enable greater use of data that may otherwise be discarded, as data from each scan can be stored and later utilised for ion current estimation.

In one implementation, at least one of the respective second analytical instruments may be the same type of analytical instrument as the first analytical instrument. In a further example, at least one of the respective second analytical instruments and the first analytical instrument may be different types of analytical instrument.

In the method, each of the stored signals has associated with it one or more second operating parameters, these being the operating parameters that were used by the first or second analytical instrument to obtain that signal. Thus, each signal of the plurality of signals is representative of an ion current obtained using the first analytical instrument configured according to the respective associated one or more second operating parameters, or using a second analytical instrument configured according to the respective associated one or more second operating parameters. The plurality of signals includes signals obtained by the first or second analytical instrument when configured according to a variety of different configurations of the one or more second operating parameters. Then, the at least one signal is selected based on the one or more first operating parameters, for example, by comparing the one or more first operating parameters to the second operating parameters, and determining the signal or signals from the plurality of stored signals that was obtained using one or more second operating parameters that are the same as, sufficiently similar to, or most similar to the one or more first operating parameters.

Thus, the one or more first operating parameters may be the same as the one or more second operating parameters. In an example, some (at least one), but not necessarily all, of the one or more first operating parameters may be the same as the one or more second operating parameters. In another example, the one or more first operating parameters may be (sufficiently) similar to the one or more second operating parameters.

Optionally, the first analytical instrument may comprise an ion trap. The method may method further comprise accumulating a batch of ions in the ion trap, and controlling the configured first analytical instrument based on the estimated ion current may comprise regulating the number of ions in the batch of ions accumulated in the ion trap based on the estimated ion current. In other words, automatic gain control may be implemented based on the estimated ion current. The automatic gain control may be more accurate due to the use of the stored data, as the most appropriate at least one signal can be used to estimate the ion current.

In one implementation, regulating the number of ions comprises controlling a fill time of the ions into the ion trap. This may provide a straightforward manner of regulating the number of ions accumulated in the trap. Regulating the number of ions by controlling a fill time may prevent or limit space charge effects and other undesired effects of over-accumulating ions.

Optionally, the ion trap may be or may comprise an ion trap mass analyser. The method may accordingly further comprise mass analysing the batch of ions in the ion trap mass analyser.

Optionally, the first analytical instrument may comprise a mass analyser and the ion trap may be arranged upstream of the mass analyser. The method may accordingly further comprise:
ejecting the batch of ions from the ion trap into the mass analyser; and
mass analysing the batch of ions in the mass analyser.

Optionally, the mass analyser may comprise an ion trap mass analyser or a time-of-flight mass analyser.

Optionally, the method may further comprise analysing ions during a time period, and controlling the configured first analytical instrument based on the estimated ion current may comprise regulating a duration of the time period based on the estimated ion current.

Optionally, the method may further comprise measuring a signal response over a period of time, wherein controlling the configured first analytical instrument based on the estimated current may comprise modulating a duration of the period of time based on the estimated ion current. Thus, automatic gain control may be implemented by controlling an accumulation time of the signal (rather than, for example, controlling a number of ions accumulated).

Optionally, controlling the configured first analytical instrument based on the estimated ion current may comprise adjusting, based on the estimated ion current, a target number of ions, an ion accumulation time and/or an m/z range. In other words, at least one of the operating parameters of the configured first analytical instrument may be changed based on the estimated ion current. The method may thus enable a more responsive automatic gain control to be implemented. For example, the estimated ion current may indicate that the target number of ions would lead to over-accumulation (resulting in undesired space charge effects). The target number of ions can thus be adjusted to prevent or reduce over-accumulation.

Optionally, the adjusting the m/z range may comprise excluding an m/z subrange within the m/z range to prevent ions within the m/z subrange being transferred or guided through the first analytical instrument. For example, the m/z subrange (target window) may be excluded where it is expected that few ions in the m/z subrange are present and/or would be accumulated in a maximum injection time. Too few ions may not provide sufficient (or sufficiently accurate) results, and so beam time may otherwise be wasted if the m/z subrange is included. A threshold expected number of ions may be used to determine whether the m/z subrange should be excluded. For example, less than 5000 ions in the maximum injection time may not provide sufficient (or sufficiently accurate) results. The threshold expected number may therefore be 5000 ions. The threshold expected number may be pre-set (for example, by a user, by analytical instrument specifications or by a computer) and may be adjustable. Other threshold expected numbers may be used such as, for example, 1000 ions or 10,000 ions.

Optionally adjusting the m/z range may additionally or alternatively comprise increasing the m/z range to transfer or guide further ions through the first analytical instrument. For example, it may be expected that too few ions in the initial m/z range would be present (for instance, accumulated in a maximum injection time) based on the estimated ion current. The m/z range (m/z window) may thus be increased (widened or extended) to allow a greater number of ions to be admitted into a component of the first analytical instrument. Too few ions may not provide sufficient (or sufficiently accurate) results. Thus, increasing the m/z window may prevent or reduce wasted beam time. As described above with reference to excluding the m/z subrange, a threshold expected number of ions may be used to determine whether the m/z range should be increased. For example, less than 5000 ions in the maximum injection time may not provide sufficient (or sufficiently accurate) results. The threshold expected number may therefore be 5000 ions. The threshold expected number may be pre-set (for example, by a user, by analytical instrument specifications or by a computer) and may be adjustable. Other threshold expected numbers may be used such as, for example, 1000 ions or 10,000 ions.

Optionally, adjusting the ion accumulation time may comprise increasing the ion accumulation time. For example, it may be expected that too few ions would be accumulated in a time period based on the estimated ion current. Thus, the ion accumulation time may be increased to accumulate more than the expected number of ions (which may be determined or calculated based on the estimated ion current). Preferably, the ion accumulation time is increased beyond a pre-set maximum ion accumulation time. The pre-set maximum ion accumulation time may have been set to avoid overload of a region (for example, an ion store or ion trap) of the first analytical instrument. However, in cases where the expected number of ions within the m/z window is low, the accumulation time may be extended beyond the pre-set maximum without (or with low) risk of overfilling the region.

Optionally, adjusting the target number of ions may comprise increasing the target number of ions from the pre-set target number of ions specified by the one or more first operating parameters (or otherwise pre-set). For example, the estimated ion current may indicate that an ion store would be underfilled based on the pre-set target number of ions. Underfill may lead to a wasted spectrum. Adjusting the target number of ions may thus improve the results obtained by the first analytical instrument.

Optionally, the one or more first and/or second operating parameters may comprise one or more of: an operation mode; a mass-to-charge ratio (m/z) range; an isolation window width; a target number of ions; at least one parameter for implementing a fragmentation method and/or information regarding a fragmentation method; a fragmentation energy; and an ion path through the first and/or respective second analytical instrument. The one or more first and/or second operating parameters may thus provide more granular detail regarding the plurality of signals. Thus, a more appropriate at least one signal can be selected, which may result in a more accurate estimation of the ion current.

In an implementation, the target number of ions may be a target number of ions to be accumulated in an ion trap and/or a target number of ions in a peak detected when controlling the first analytical instrument. This may enable the overall ion population and/or ion population of the peak (respectively) to be limited when controlling the first analytical instrument. Either or both of these ion populations being too high may result in space charge effects, which negatively impact the results of an analytical instrument. Thus, specifying a target number of ions as a target number of ions to be accumulated in an ion trap and/or a target number of ions in a detected peak may enable space charge effects to be prevented or reduced. Furthermore, the respective one or more second operating parameters including this information may be useful for selecting the at least one signal. For example, selecting a signal that was obtained for the same or a sufficiently or most similar target number of ions may enable a more accurate ion current estimation.

Optionally, the fragmentation energy may be a collision energy. The one or more first and/or second operating parameters may thus provide more granular detail regarding the plurality of signals. Thus, a more appropriate at least one signal can be selected, which may result in a more accurate estimation of the ion current.

Preferably, the one or more first and/or second operating parameters may comprise one or more component operating parameters of at least one component of the respective first and/or second analytical instrument. The one or more first and/or second operating parameters may provide more granular detail regarding the plurality of signals. Thus, a more appropriate at least one signal can be selected, which may result in a more accurate estimation of the ion current.

Optionally, the at least one component comprises one or more of: a mass analyser; an ion guide; an ion gate; a mass filter; a fragmentation cell; an ion source; an ion trap; and a detector. The one or more first and/or second operating parameters may thus provide more granular detail regarding the plurality of signals. Thus, a more appropriate at least one signal can be selected, which may result in a more accurate estimation of the ion current.

Preferably, the one or more first and/or second operating parameters comprise a type of mass analyser. This is particularly useful where the first and/or second analytical instrument is a dual mass analyser analytical instrument, that is, where the first and/or second analytical instrument comprises a first mass analyser and second mass analyser. The first and second mass analysers may be mass analysers of different types. For example, the first mass analyser may be an ion trap mass analyser, a Fourier Transform mass analyser, or an orbital trapping mass analyser, and the second mass analyser may be a time-of-flight mass analyser. Other combinations of different types of mass analyser would be possible. More than two mass analysers may be provided. Then, the one or more first and/or second operating parameters may specify which type of mass analyser was used for the particular stored signal and/or which type of mass analyser is to be used when controlling the configured first analytical instrument based on the estimated ion current (to obtain a mass spectrum). Thus, a more appropriate at least one signal can be selected (for example, the at least one signal may be a signal obtained using the same type of mass analyser as is to be used for the new scan), which may result in a more accurate estimation of the ion current.

Preferably, the one or more component operating parameters may comprise a type of mass analyser. For instance, the one or more component operating parameters may specify that a mass analyser of the first analytical instrument is an ion trap mass analyser, a Fourier Transform mass analyser, or a time-of-flight mass analyser. The Fourier Transform mass analyser may preferably be an orbital trapping mass analyser. The one or more operating parameters may specify more than one type of mass analyser (for instance, in a hybrid mass spectrometer). The one or more first and/or second operating parameters may thus provide more granular detail regarding the plurality of signals. Thus, a more appropriate at least one signal can be selected, which may result in a more accurate estimation of the ion current.

Preferably, the one or more component operating parameters may comprise a type of scan. The type of scan may be a parameter of more than one component. For example, as well as defining the operating parameters for a mass analyser, the type of scan may be relevant to component operating parameters of, for instance, a mass filter (for example, a mass filter isolation width or isolation window centre m/z value). Accordingly, the type of scan may also be considered as more generally one of the one or more first and/or second operating parameters. The type of scan may comprise an MS1 and/or an MS2 scan. In another example, the type of scan may comprise a pre-scan. A pre-scan may be a scan having a minimum inject time and may be a relatively fast scan. The one or more first and/or second operating parameters may thus provide more granular detail regarding the plurality of signals. The one or more first and/or second operating parameters may specify the type of scan associated with the stored signal and/or which type of scan is to be obtained when controlling the configured first analytical instrument based on the estimated ion current. Thus, a more appropriate at least one signal can be selected (for example, the at least one signal may be a signal obtained using the same type of scan as is to be used for the new scan), which may result in a more accurate estimation of the ion current.

Preferably, the one or more first and/or second operating parameters may comprise an isolation window width and/or isolation window centre m/z value (for example, used or to be used for an MS2 scan). Then, the one or more first and/or second operating parameters may specify the isolation window width and/or the isolation window centre m/z value associated with the stored signal, and/or the isolation window width and/or the isolation window centre m/z value to be used when controlling the configured first analytical instrument based on the estimated ion current. Thus, a more appropriate at least one signal can be selected (for example, the at least one signal may be a signal obtained using the same or a similar isolation window width and/or isolation window centre m/z value as is to be used for the new scan), which may result in a more accurate estimation of the ion current.

In a further implementation, the m/z range may comprise an m/z scan range. The one or more first and/or second operating parameters may thus provide more granular detail regarding the plurality of signals. Thus, a more appropriate at least one signal can be selected, which may result in a more accurate estimation of the ion current.

In another implementation, the one or more component operating parameters comprise an amplitude and/or frequency of one or more RF and/or DC potentials applied to the at least one component. The RF and/or DC potentials may define the operation of the first analytical instrument (for example, whether a fragmentation chamber is configured to fragment precursor ions). The RF and/or DC potentials may thus provide additional information regarding the stored signals, even if the one or more component operating parameters do not explicitly specify, for example, an operation mode. Thus, a more appropriate at least one signal can be selected, which may result in a more accurate estimation of the ion current.

Preferably, the one or more first and/or second operating parameters comprise a fragmentation energy, for example, used or to be used for an MS2 scan. Then, the one or more first and/or second operating parameters may specify the fragmentation energy associated with the stored signal, and/or the fragmentation energy to be used when controlling the configured first analytical instrument based on the estimated ion current. Thus, a more appropriate at least one signal can be selected (for example, the at least one signal may be a signal obtained using the same or similar fragmentation energy as is to be used for the new scan), which may result in a more accurate estimation of the ion current. A similar fragmentation energy may be a fragmentation energy within a threshold tolerance of the fragmentation energy to be used for the new scan.

Preferably, the operation mode may comprise a component operation mode. Different operation modes may provide different advantages. For example, one component operation mode may provide high transmission rates versus a second component operation mode that may provide high resolution scans. Including this information in the stored data may therefore allow more appropriate selection of the at least one signal depending on the relative advantages. This may allow more accurate ion current estimation. Furthermore, knowledge of which component operation mode was used to obtain the respective signal may enable more accurate ion current estimation.

The first and/or second analytical instrument may comprise a multi-reflection time-of-flight (MR-ToF) mass analyser. The MR-ToF mass analyser may comprise:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injected located in proximity with the first end of the ion mirrors;
a deflector or lens located in proximity with the first end of the ion mirrors; and
a detector for detecting ions after they have completed plural reflections in the ion mirrors.

The MR-ToF mass analyser may be configured to analyse ions by injecting ions from the ion injector into the space between the ion mirrors, such that the ions follow an ion path having one or more oscillation(s) between the ion mirrors in the direction X whilst drifting in the drift direction Y from the ion injector to the detector. The number of oscillation(s) that ions make between the ion mirrors in the direction X whilst drifting in the drift direction Y from the ion injector to the detector may be controlled by controlling a voltage applied to the deflector or lens.

The MR-ToF mass analyser may be operable in a “normal” mode of operation wherein ions are analysed by injecting ions from the ion injector into the space between the ion mirrors, wherein the ions follow a zigzag ion path having plural reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y to the first end of the ion mirrors. The ions are then causes to travel to the detector for detection.

The MR-ToF mass analyser may be operable in a single oscillation mode of operation wherein ions are caused to make a single oscillation between the ion mirrors in the direction X whilst drifting in the drift direction Y from the ion injector to the detector. In some embodiments, the stored data may include at least one signal obtained using the first and/or second analytical instrument when configured in the single oscillation mode of operation.

Thus, in one advantageous implementation, the component operation mode may be a single oscillation mode of a multi-reflection time-of-flight (MR-ToF) mass analyser, in which ions are caused to make a single oscillation in a first direction between ion mirrors spaced apart and opposing each other in the first direction whilst drifting in a drift direction from an ion injector to a detector by controlling a voltage applied to a deflector or lens, the drift direction being a direction along which each mirror is generally elongated and that is orthogonal to the first direction. As the ions take a relatively short path within the MR-ToF analyser, a single oscillation mode scan can be performed quickly and straightforwardly. The single oscillation mode may thus be used as a pre-scan for estimating the ion current. The single oscillation mode can therefore be used to obtain up-to-date data to be included in the stored data (at least one signal representing an ion current from the pre-scan may be stored in the stored data). Furthermore, as the ions only make a single oscillation between the ion mirrors, the single oscillation mode may benefit from high ion transmission and few losses due to collisions with background gas. This data may also be obtained without significantly wasting beam time.

The MR-ToF mass analyser may be operable in multiple cycle (or “zoom”) mode of operation wherein ions are analysed by:
(i) injecting ions from the ion injector into the space between the ion mirrors, wherein the ions complete a first cycle in which the ions follow a zigzag ion path having plural reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(ii) reversing the drift direction velocity of the ions in proximity with the first end of the ion mirrors such that the ions are caused to complete a further cycle in which the ions follow a zigzag ion path having plural reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(iii) optionally repeating step (ii) one or more times; and then
(iv) causing the ions to travel to the detector for detection.

In some embodiments, the stored data may include at least one signal obtained using the first and/or second analytical instrument when configured in the multiple cycle mode of operation.

Thus, in another implementation, the component operation mode may be a multiple cycle mode, in which ions are caused to perform multiple cycles of a plurality of oscillations in the first direction between the ion mirrors by using a deflector to reverse a drift velocity direction of the ions one or more times after an initial cycle. As the ions complete a plurality of cycles within the MR-ToF analyser, the path of the ions increases. This provides greater separation of ions having different m/z values (and the multiple cycle mode may equivalently be called a zoom mode for at least this reason). Thus, the multiple cycle mode may provide higher resolution scans. This may be useful for more accurately estimating the ion current, and these higher resolution scans may be obtained more quickly and straightforwardly than other high resolution scans (for example, from an orbital trapping mass analyser). The zoom mode may thus be used as a pre-scan for estimating the ion current. Furthermore, as the multiple cycle mode may result in a broader ToF peak, the dynamic range of the MR-ToF analyser may be increased. This may be useful for a current measurement of an intense ion species. This may in turn be useful for more accurately estimating the ion current.

In some embodiments, the one or more first and/or second operating parameters comprise the MR-ToF mode of operation. Then, the one or more first and/or second operating parameters may specify the MR-ToF mode of operation associated with the stored signal, and/or the MR-ToF mode of operation to be used when controlling the configured first analytical instrument based on the estimated ion current, e.g. as being one of a normal mode of operation, a single oscillation mode of operation, a zoom mode of operation, or another mode of operation. Thus, a more appropriate at least one signal can be selected (for example, the at least one signal may be a signal obtained using the same or similar MR-ToF mode of operation as is to be used for the new scan), which may result in a more accurate estimation of the ion current.

Preferably, the first and/or respective second analytical instrument may comprise the at least one component. In one implementation, the component operation mode of the (at least one component of the) first analytical instrument is different to the component operation mode of the (at least one component of the) analytical instrument using which the at least signal was obtained (which may be the first and/or respective second analytical instrument). The advantages of each component operation mode can thus be obtained, whilst also enabling an accurate ion current estimation. In another example, the component operation modes of the first analytical instrument and the analytical instrument using which the at least one signal was obtained may be the same or similar. The component operation mode being similar may mean that the two operation modes provide the same results to within a threshold tolerance, or that the two operation modes operate under a corresponding principle (for example, a zoom mode). The component operation modes being the same or similar may further improve the ion current estimation.

In one implementation, the component operation mode of one of the first analytical instrument and the analytical instrument using which the at least one signal was obtained may be a higher resolution component operation mode than the component operation mode of the other one of the first analytical instrument and the analytical instrument using which the at least one signal was obtained. The lower resolution mode current measurement may thus be used to determine a current estimation for the higher resolution mode (or vice versa). The component operating parameters of the first analytical instrument and the analytical instrument using which the at least one signal was obtained may otherwise be the same (or similar). Thus, the lower resolution mode may be useful for more accurately estimating an ion current for the higher resolution mode (or vice versa), whilst also enabling the first analytical instrument to benefit from any associated with the other resolution mode (for example, being quicker to perform).

Optionally, the one or more component operating parameters may comprise a type of detector. Different types of detector may have different dynamic ranges or otherwise potentially provide different information or results (for example, in a different measurement unit). In some embodiments, the stored data may include signals obtained using different types of detector. The one or more component operating parameters specifying a type of detector may enable more accurate ion current estimation in view of the different types of detector. The type of detector may preferably comprise a liquid chromatography (LC) detector. An LC detector may beneficially provide supporting information that may improve the ion current estimation. Additionally or alternatively, the type of detector may comprise an electrometer. An electrometer may beneficially provide supporting information that may improve the ion current estimation. For example, electrometer data may enable improved ion current estimation for highly multiply charged ions.

Preferably, the selecting may comprise applying one or more filtering criteria to the stored data to obtain a subset of data, the subset of data comprising the at least one signal and the respective one or more second operating parameters. Moreover, filtering the stored data may allow more relevant data to be prioritised, which may enable an appropriate signal of the plurality of signals to be selected in a quick and straightforward manner. This may be useful when there are large amounts of stored data. Selecting a more appropriate signal via filtering the stored data may allow a more accurate ion current estimation.

Preferably, the one or more filtering criteria may be based on one or more of: at least one of the one or more first operating parameters, at least one of the respective one or more second operating parameters, a number of detected ions, a time duration since obtaining a signal of the plurality of signals, a retention time duration, and an overfill indication. Filtering the stored data based on one or more of these options may allow a more appropriate signal for ion current estimation to be selected, which may in turn enable more accurate ion current estimation. Thus, better automatic gain control may be implemented and the first analytical instrument may provide more accurate results.

In one optional implementation, the one or more filtering criteria may comprise at least one of the one or more first operating parameters and at least one of the respective one or more second operating parameters being the same or sufficiently similar. Thus, signals corresponding to the same or similar circumstances may be prioritised, which may allow a more accurate ion current estimation.

Optionally, the one or more filtering criteria may comprise the number of detected ions being greater or less than a threshold number of detected ions. Thus, signals corresponding to the same or similar circumstances may be prioritised, which may allow a more accurate ion current estimation.

Optionally, the one or more filtering criteria may also or instead comprise a target number of ions being within a threshold tolerance of the detected number of ions. Thus, signals in which the target number of ions and the detected number of ions were similar may be prioritised over signals in which there is a large discrepancy between the target number of ions and the detected number of ions. This may enable more accurate ion current estimation, which in turn may provide more accurate automatic gain control.

Optionally, the one or more filtering criteria may also or instead comprise a time duration since obtaining the at least one signal being less than a threshold time duration. Thus, signals that are newer may be prioritised, which may enable more accurate ion current estimation. For example, there may have been a sudden shift in signal that would lead to less accurate ion current estimation when estimating the ion current based on an older signal.

Optionally, the one or more filtering criteria may also or instead comprise a retention time duration being less than a threshold retention time duration. A signal obtained for a sample having a similar threshold retention time may enable more accurate ion current estimation.

Optionally, the controlling may comprise measuring a further signal representative of the ion current and, subsequent to the controlling, including the further signal and the one or more first operating parameters in the stored data. Thus, the stored data can be updated with more up-to-date data. Furthermore, the variety of data in the stored data may be increased, which may enable more accurate future ion current estimations. Additional data obtained during the controlling (for example, detector data, mass spectra or other data) may also be included in the stored data, along with the further signal and the one or more first operating parameters.

Optionally, the at least one signal may comprise more than one signal and the estimating further comprises weighting the more than one signals to estimate the ion current. Thus, greater use of the stored data can be made. Multiple signals may enable a more accurate ion current estimation, as more of the stored data may be taken into account in the ion current estimation and the various advantages and/or disadvantages of various operating parameters (for example, scan type or mass analyser type) can be balanced.

Optionally, the selecting may comprise using an algorithm, a graph, a mathematical model, or a machine learning model to select the at least one signal. The criteria for selecting the at least one signal may thus be more complex and can take into account multiple data points, which may enable a more accurate ion current estimation. Optionally, wherein the selecting comprises using a decision tree or random forest to select the at least one signal. A decision tree may be a straightforward method of selecting a signal. A random forest may outperform some decision tree methods.

Optionally, the stored data may further comprise scan data for one or more of the plurality of signals, wherein the scan data preferably comprises one or more of: one or more acquired mass spectra, information regarding one or more detected peaks, an m/z range and ion accumulation time. Additional data (that is, data in addition to the signal representative of the ion current) can thus be taken into account in the ion current estimation, which may enable a more accurate estimation.

Optionally, the information regarding detected peaks may comprise an intensity and/or resolution of the peaks. Intensity information may be useful for calculating one or more correction factors to match intensity reporting. Either or both of the intensity and resolution information may be useful for indicating that a signal is less appropriate for selection. For example, the intensity of the one or more detected peaks may indicate a low ion intensity, which may suggest that there are not enough fragments for identification or quantification. In another example, the resolution information may indicate that the spectrum may be of poor quality and therefore may not enable the most accurate ion current estimation.

Optionally, the stored data further may comprise one or more of: pre-scan data, one or more ion current measurements, one or more electrometer measurements, LC detector data, and data from one or more previous experiments. Such data may be particularly useful for supporting the ion current estimation.

Preferably, the first analytical instrument may comprise a first mass analyser and a second mass analyser. Preferably, the first mass analyser may comprise an orbital trapping mass analyser and the second mass analyser may comprise an MR-ToF analyser. An orbital trapping mass analyser may be capable of high resolution scans and the MR-ToF analyser may provide fast scans with single ion sensitivity, whilst still benefiting from a high resolving power. The orbital trapping mass spectrometer and MR-ToF may thus operate well together.

In one implementation, controlling the first analytical instrument may comprise performing a plurality of analysis cycles, wherein each cycle comprises:
performing a single analysis across an m/z range in an MS1 domain using the first mass analyser; and
performing a plurality of analyses across the m/z range in the MS1 domain using the second mass analyser; and
performing analyses of precursor ions in the MS2 domain using the second mass analyser.

Thus, ion current information from the first and second mass analysers may be used to support the other analyser. This may be particularly useful for rapidly changing signals, such as may occur in liquid chromatography, for example.

When the second analyser is an MR-ToF analyser, the analyses in the MS1 domain may be able to be carried out frequently and at relatively low time overhead.

In another implementation, performing the plurality of analyses in the MS1 domain by the second mass analyser may comprise subdividing the m/z range into a plurality of m/z subranges and performing an analysis across each m/z subrange in the MS1 domain using the second mass analyser.

Optionally, the analyses performed in the MS1 and MS2 domains by the second mass analyser may be performed concurrently with the single analysis in the MS1 domain performed by the first mass analyser. Thus, the analyses performed in the MS1 domain by the second mass analyser may be able to inform the analysis in the MS1 domain performed by the first mass analyser and the analyses in the MS2 domain using the second mass analyser. For example, the analysis performed in the MS1 domain by the second mass analyser may indicate a shift in signal that can be taken into account in the results from the single analysis. The analyses performed in the MS1 domain by the second mass analyser may also enable ion current estimation for determining an ion accumulation time for the analyses in the MS2 domain.

When the second analyser is an MR-ToF analyser, the analyses in the MS1 domain may be able to be carried out frequently and at relatively low time overhead. When the first analyser is also an orbital trapping mass analyser, the MR-ToF MS1 analyses may bridge the gap between the slower orbital trapping mass analyser MS1 scan and a rapidly changing signal (for example, in liquid chromatography coupled analysers).

In a further implementation, the plurality of analyses performed in the MS1 domain by the second mass analyser may be interleaved with the analyses performed in the MS2 domain by the second mass analyser. This may further facilitate use of the MS1 analyses for ion population control for the MS2 analyses.

Optionally, for each analysis cycle, at least 3, 5, or 7 analyses may be performed in the MS1 domain by the second mass analyser. This may enable multiple points to be generated for a changing signal (for instance, an LC peak elution), which may enable each analysis by the second mass analyser to most effectively regulate the next.

Optionally, the plurality of analyses performed in the MS1 domain by the second mass analyser may be interleaved evenly throughout the duration of the analysis performed in the MS1 domain by the first mass analyser.

In one implementation, the controlling may comprise scheduling one or more steps in an ion analysis procedure based on the estimated ion current. For example, it may be useful to perform an MS2 measurement at or near the apex of a chromatographic peak, as this may minimise the beam time required per precursor ion. The estimated ion current may thus be used to schedule the MS2 measurement to coincide (to within a threshold tolerance) with the chromatographic peak. Scheduling the one or more steps may comprise determining a point in time for the one or more steps to occur and programming the one or more steps to occur at the point in time.

Optionally, the scheduling may be based on one or more of the plurality of analyses in the MS1 domain using the second mass analyser. For example, an apex of a chromatographic (or ion drift) peak may be estimated (and this may include estimating a time at which the apex may occur) and the scheduling may comprise scheduling the one or more steps such that the point in time occurs within a threshold time period of an expected chromatographic (or ion drift) peak apex occurrence. In another implementation, the point in time may be distinct from the time at which the apex is expected to occur (for example, outside of the threshold time period). Optionally, the scheduling may comprise scheduling the one or more steps such that the point in time occurs within a threshold time period of an expected chromatographic peak minimum occurrence. The peak apex and/or peak minimum may be estimated by modelling a peak shape based on the one or more analyses of the plurality of analyses in the MS1 domain using the second mass analyser. In another example, the peak apex and/or peak minimum may be estimated based on a peak width (which may be included in the stored data)

In another implementation, the further signal representative of the ion current comprises one or more signals obtained from the plurality of analyses that are representative of the ion current. The data obtained from the plurality of analyses may be useful for many purposes. It is therefore beneficial to include this information in the stored data, so that this information may be used in the future.

Preferably, the method may further comprise, in response to receiving additional data after a storage threshold of the stored data is reached, deleting or overwriting one or more data entries in the stored data to include the additional data in the stored data. This may prevent the amount of data in the stored data from becoming too large, which may slow selection of the at least one signal.

Preferably, the storage threshold may correspond to a maximum number of data entries and/or a maximum storage capacity.

Preferably, the deleting or overwriting may comprise deleting or overwriting one or more data entries stored for longer than a threshold time period and/or deleting or overwriting one or more oldest stored data entries. Thus, data entries less likely to be useful or relevant may be overwritten before more up-to-date entries.

Preferably, the stored data may comprise a set of editable data and a set of non-editable data and the deleting or overwriting comprises deleting one or more data entries in the set of editable data. This may allow certain background information to be retained, even when the storage threshold has been reached.

Optionally, data may be stored as non-editable data based on one or more of: a type of scan from which the data was obtained, an expected performance frequency of the type of scan, and a time duration since the type of scan was last performed. Thus, data relating to scans rarely performed, or at least not performed recently, and/or data relating to particularly useful scan types may be retained, even when the storage threshold has been reached.

Preferably, wherein the data may be stored as non-editable data based on the expected performance frequency being less than a threshold frequency and/or the time duration being more than a threshold time duration. Thus, data relating to scans rarely performed, or at least not performed recently may be retained, even when the storage threshold has been reached.

The above methods may be implemented by a controller configured to operate an analytical instrument, particularly an analytical instrument for ion analysis, which may be referred to herein as an (ion) analytical instrument. The analytical instrument may be or may comprise a mass spectrometer. A mass spectrometer is a type of analytical instrument that typically comprises an ion source, transfer ion optics and a mass analyser. Similarly, the above methods may be implemented in a system comprising an analytical instrument and a controller configured to operate the analytical instrument.

The methods described above may be implemented as a computer program comprising instructions to operate a computer or computer system. The computer program may be stored on a non-transitory computer-readable medium. The computer or computer system (or other hardware and/or software configured to implement the method) may be embodied as a controller configured to operate an analytical instrument.

The above methods may be implemented in a system comprising a first (ion) analytical instrument, the controller and a database in communication with the first (ion) analytical instrument. The first analytical instrument may comprise a liquid chromatography arrangement and the controller may be configured to operate the liquid chromatography arrangement.

It should be noted that any feature described herein may be used with any particular aspect or embodiment of the invention. Moreover, the combination of any specific apparatus, structural or method features is also provided, even if that combination is not explicitly disclosed.

The invention will now be described with reference to the attached drawings depicting different embodiments thereof, the drawings being provided purely by way of example and not limitation.

### BRIEF DESCRIPTION OF DRAWINGS

The invention may be put into practice in a number of ways, and preferred embodiments will now be described by way of example only and with reference to the accompanying drawings, in which:

FIG. 1 schematically shows a hybrid mass spectrometer incorporating an orbital trapping mass analyser and a time-of-flight analyser;

FIG. 2 shows a diagram of ion paths during injection, trapping and extraction of ions in a time-of-flight analyser;

FIG. 3 illustrates a flow chart of a method of controlling an analytical instrument according to an embodiment of the disclosure;

FIG. 4A shows a flow chart of a method of operating an analytical instrument according to an embodiment of the disclosure;

FIG. 4B illustrates optional filtering criteria and AGC strategies that may be implemented in the method illustrated in FIG. 4A;

FIG. 5 illustrates an acquired mass spectrum obtained from an MS1 scan of a Pierce (RTM) FlexMix (RTM) calibration solution and an MS2 spectrum of the isolated MRFA peptide (m/z 524);

FIG. 6 shows a block diagram of a method of tandem mass spectrometry according to an embodiment of the disclosure;

FIG. 7 shows a graph indicating a regulated ion accumulation time and resulting ion current over a period of time of sample elution in a liquid chromatography analyser; and

FIG. 8 illustrates selection of a AGC calculation method for a number of scans over a period of time.

It should be noted that the Figures are illustrated in schematic form for simplicity and are not necessarily drawn to scale. Like features are provided with the same (or similar) reference numerals.

### DESCRIPTION OF PREFERRED EMBODIMENTS

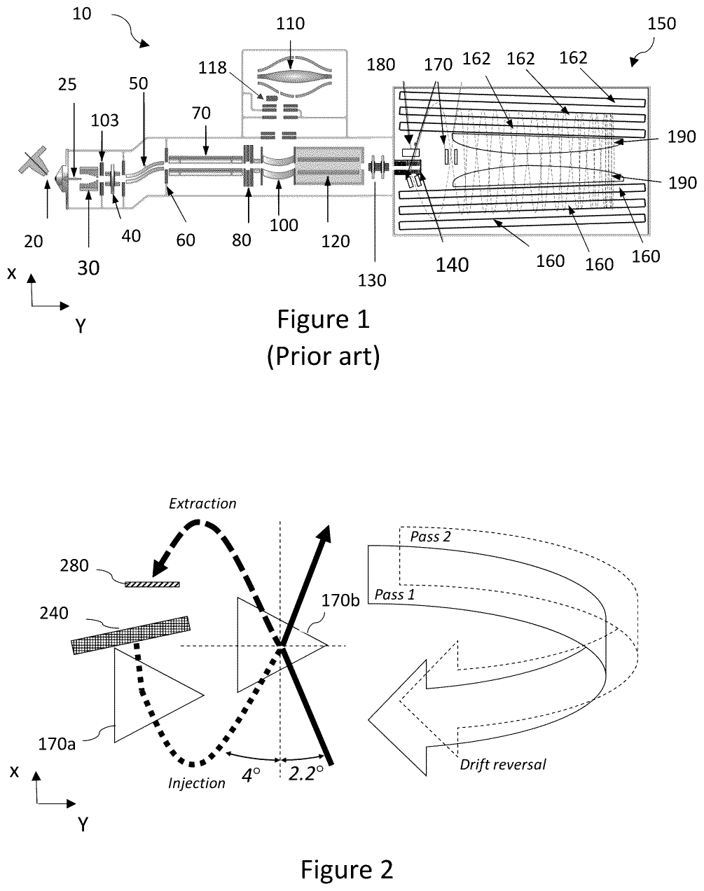

FIG. 1 shows a schematic arrangement of a tandem mass spectrometer 10 suitable for carrying out methods in accordance with embodiments of the present disclosure. The tandem mass spectrometer 10 may be similar to that described in U.S. Pat. No. 10,699,888 B2, for example.

In FIG. 1, a sample to be analysed may be supplied (for example, from an autosampler) to a chromatographic apparatus such as a liquid chromatography (LC) column (not shown in FIG. 1). One such example of an LC column is the Thermo Fisher Scientific, Inc ProSwift (RTM) monolithic column, which can offer high performance liquid chromatography (HPLC) through the forcing of the sample carried in a mobile phase under high pressure through a stationary phase of irregularly or spherically shaped particles constituting the stationary phase. In the HPLC column, sample molecules elute at different rates according to their degree of interaction with the stationary phase.

The sample molecules (for example, as separated via liquid chromatography) are ionized using an ion source to generate precursor ions. In the embodiment of FIG. 1, the ion source is an electrospray ionization source (ESI source) 20 that is at atmospheric pressure. However, it will be understood that other ion sources may be used instead to generate ions. For example, an electron ionisation (EI), chemical ionisation (CI), or matrix-assisted laser desorption/ionisation (MALDI) source may be used.

Precursor ions generated by the ESI source 20 then enter a vacuum chamber or vacuum interface of the tandem mass spectrometer 10 and are directed by a capillary 25 into an electrodynamic ion funnel 30. In some embodiments, the ion funnel 30 may be replaced by an RF-only S-lens. The precursor ions are focused by the ion funnel 30 into a first ion guide. The ion guide may be a quadrupole pre-filter 40 which injects the precursor ions into a second ion guide. The second ion guide may be a bent flatapole 50, which may have an axial field. The bent flatapole 50 guides (charged) precursor ions along a curved path through it, whilst unwanted neutral molecules, such as entrained solvent molecules (for example) are not guided along the curved path and are lost. The bent flatapole 50 may be of any suitable curved shape. For example, the bent flatapole 50 may be an arc-shape.

An ion lens 60 is located at the distal end of the bent flatapole 50 and may controls the passage of the precursor ions from the bent flatapole 50 into a downstream mass selector in the form of a quadrupole mass filter 70. Alternatively, the ion funnel 30 may be operated as an ion gate and the ion gate (TK lens) 60 may be a static lens. In embodiments, the ion funnel 30 may be replaced by a RF-only S lens, which may optionally be operated in the same manner. The quadrupole mass filter 70 is typically but not necessarily segmented and serves as a band pass filter, allowing passage of a selected mass number or limited mass range whilst excluding precursor ions of other mass to charge ratios (m/z). For example, the quadrupole mass filter 70 may be controlled by a controller (not shown in FIG. 1) to select a range of mass-to-charge ratios to pass (of the precursor ions which are allowed to pass), whilst the other ions in the precursor ion stream are filtered out (not allowed to pass). As such, the mass filter 70 may filter the precursor ions based on an m/z range of interest. The mass filter 70 can also be operated in an RF-only mode in which it is not mass selective. That is, the mass filter 70 may transmit substantially all m/z precursor ions.

Although a quadrupole mass filter 70 is shown in FIG. 1, the skilled person will appreciate that other types of mass selection devices may also be suitable for selecting precursor ions within the mass range of interest. For example, an ion separator as described in US-A-2015287585, an ion trap as described in WO-A-2013076307, an ion mobility separator as described in US-A-2012256083, an ion gate mass selection device as described in WO-A-2012175517, or a charged particle trap as described in U.S. Pat. No. 7,999,223 may be used, the contents of which are hereby incorporated by reference in their entirety. The skilled person will appreciate that other methods of selecting precursor ions according to ion mobility, differential mobility and/or transverse modulation may also be suitable.

The isolation of a plurality of precursor ions of different masses or mass ranges may also be performed using the method known as synchronous precursor scanning (SPS) in an ion trap. Furthermore, in some embodiments, more than one ion selection or mass selection device may be provided. For example, a further mass selection device may be provided downstream of a fragmentation chamber 120 (which may also be referred to herein as a collision cell or Ion-Routing Multipole, IRM). In this way, MS3 or MSn scans can be performed if desired (typically using a time-of-flight mass analyser for mass analysis).

The tandem mass spectrometer 10 may be operated in various modes of operation in order to perform analysis of the precursor ions in the MS1 domain and/or the MS2 domain. In a first mode of operation, the precursor ions may be analysed in the MS1 domain using a first mass analyser (orbital trapping mass analyser 110).

In the first mode of operation, precursor ions may pass through a quadrupole exit lens/split lens arrangement 80 and into a curved linear ion trap (C-trap) 100. The precursor ions may optionally pass into the C-trap 100 via a first transfer multipole (not shown). The C-trap (first ion trap) 100 has longitudinally extending, curved electrodes which are supplied with RF voltages and end caps that to which DC voltages are supplied. The result is a potential well that extends along the curved longitudinal axis of the C-trap 100. In a first mode of operation, the DC end cap voltages are set on the C-trap so that ions arriving from the first transfer multipole are captured in the potential well of the C-trap 100, where they are cooled. Cooled precursor ions reside in a cloud towards the bottom of the potential well of the C-trap 100. The injection time of the ions into the C-trap determines the number of precursor ions (ion population) that is subsequently ejected from the C-trap 100. From the C-trap 100, precursor ions may be directed to different parts of the tandem mass spectrometer 10, depending on the analysis to be performed.

Where precursor ions are to be analysed by the orbital trapping mass analyser 110 (first mass analyser), the precursor ions are ejected orthogonally from the C-trap towards the orbital trapping mass analyser 110. As shown in FIG. 1, the orbital trapping mass analyser 110 may be an Orbitrap (RTM) mass analyser sold by Thermo Fisher Scientific, Inc. The orbital trapping mass analyser 110 has an off-centre injection aperture and the precursor ions are injected into the orbital trapping mass analyser 110 as coherent packets, through the off-centre injection aperture. Precursor ions are then trapped within the orbital trapping mass analyser 110 by a hyperlogarithmic electric field and undergo back and forth motion in a longitudinal direction whilst orbiting around the inner electrode.

The axial component of the movement of the ion packets in the orbital trapping mass analyser 110 is (more or less) defined as simple harmonic motion, with the angular frequency in the z direction being related to the square root of the mass to charge ratio of a given ion species. Thus, over time, precursor ions separate in accordance with their mass to charge ratio.

Precursor ions in the orbital trapping mass analyser 110 are detected by use of an image current detector (not shown) which produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing ion intensity versus m/z, can be produced. As used herein, “intensity” may refer to any suitable metric indicative of or related to detected intensity, such as abundance, relative abundance, ion count, intensity, or relative intensity.

In the configuration described above, the precursor ions within the mass range of interest (selected by the quadrupole mass filter 70) are analysed by the orbital trapping mass analyser 110 without fragmentation. The resulting mass spectrum is denoted MS1.

Although an orbital trapping mass analyser 110 is shown in FIG. 1, it will be appreciated that other mass analysers may be employed as the first mass analyser according to embodiments of this disclosure. For example, a Fourier Transform Ion Cyclotron Resonance (FTICR) mass analyser may be utilised as first mass analyser to analyse the precursor ions in the MS1 domain. Mass analysers, such as the orbital trapping mass analyser and Ion Cyclotron Resonance mass analyser, may also be used in the present disclosure even where other types of signal processing than Fourier transformation are used to obtain mass spectral information from the transient signal (for example, as discussed in WO-2013/171313). In some embodiments, a ToF mass analyser may also be used in place of the orbital trapping mass analyser 110 to analyse the precursor ions in the MS1 domain.

In a second mode of operation of the tandem mass spectrometer 10, precursor ions may be analysed by the ToF mass analyser 150 (second mass analyser) in the MS1 domain. The precursor ions to be analysed by the second mass analyser may be mass filtered by the quadrupole mass filter 70. As such, the precursor ions may be filtered to include precursor ions from the m/z range of interest, or from a m/z subrange of interest.

In order for the ToF mass analyser 150 to analyse precursor ions, precursor ions may pass from the quadrupole exit lens/split lens arrangement 80 (and, optionally the first transfer multipole) into the C-trap 100 and continue their path through the C-trap 100 and into the fragmentation chamber 120. As such, the C-trap 100 may effectively be operated as an ion guide in the second mode of operation. Alternatively, cooled ions in the C-trap 100 may be ejected from the C-trap in an axial direction into the fragmentation chamber 120. As the precursor ions are to be analysed in the MS1 domain, the fragmentation chamber (IRM) 120 is not used to fragment the precursor ions. For example, the ions may not be subjected to a collision gas or the energy of the precursor ions may be insufficient to fragment the precursor ions when they collide with the collision gas. Thus, the precursor ions may continue through the fragmentation chamber 120 and be ejected from the fragmentation chamber 120 at the opposing axial end to the C-trap 100. As such, the fragmentation chamber 120 may also effectively be operated as an ion guide in the second mode of operation.

The ejected precursor ions pass into a second transfer multipole 130. The second transfer multipole 130 may guide the precursor ions from the fragmentation chamber 120 into an extraction trap (second ion trap) 140. The extraction trap 140 may be a radio frequency voltage-controlled trap containing a buffer gas. A suitable buffer gas is nitrogen at a pressure in the range 5×10⁻⁴ mbar to 1×10⁻² mbar, but other buffer gases may be used. The extraction trap has the ability to quickly switch off the applied RF voltage and apply a DC voltage to extract the trapped precursor ions. A suitable flat plate extraction trap, also referred to as a rectilinear ion trap, is further described in U.S. Pat. No. 9,548,195 (B2). Alternatively, a second C-trap may also be suitable for use as a second ion trap.

The extraction trap 140 is provided to form an ion packet of precursor ions, prior to injection into the ToF mass analyser 150. The extraction trap 140 accumulates ions prior to injection of the precursor ions into the ToF mass analyser 150.

Although an extraction trap 140 (ion trap) is shown in the embodiment of FIG. 1, the skilled person will appreciate that other methods of forming an ion packet of precursor ions will be equally suitable for the present disclosure. For example, relatively slow transfer of ions through a multipole can be used to affect bunching of ions, which can subsequently be ejected as a single packet to the ToF mass analyser. Alternatively, orthogonal displacement of precursor ions may be used to form a packet. Further details of these alternatives are found in US-A-20030001088, which describes a travelling wave ion bunching method, the contents of which are herein incorporated by reference.

In FIG. 1, the ToF mass analyser 150 shown is a multiple reflection time of flight mass analyser (MR-ToF), which may be similar to that described in U.S. Pat. No. 9,136,101 B2. The ToF analyser 150 in FIG. 1 comprises a pair of ion mirrors (first and second ion mirrors) 160, 162 spaced apart and opposing each other in a first direction X. The ion mirrors 160, 162 are generally elongated along a drift direction Y that is orthogonal to the first direction.

The extraction trap 140 injects ions into the first mirror 160 and the ions then oscillate between the two mirrors 160, 162. The angle of ejection of ions from the extraction trap 140 and additional deflectors 170 allow control of the energy of the ions in the drift direction, such that ions are directed down the length of the mirrors 160, 162 as they oscillate, producing a zig-zag trajectory.

The ions oscillate between the ion mirrors 160, 162 and drift down the length of the ion mirrors at an injection angle set by a pair of deflectors 170. The ion mirrors 160, 162 tilted relative to one another to create a retarding potential that reverses the ion drift, so that the ion path is slowly deflected and redirected back to a detector 180 or lens. The tilting of the opposing mirrors may normally have the negative side-effect of changing the time period of ion oscillations as they travel down the drift dimension. However, this can be corrected for with a stripe electrode 190 (to act as a compensation electrode) that alters the flight potential for a portion of the inter-mirror space, varying down the length of the opposing mirrors 160, 162. The combination of the varying width of the stripe electrode 190 and variation of the distance between the mirrors 160, 162 allows the reflection and spatial focusing of ions onto the detector 180, as well as maintaining a good time focus. An MR-ToF suitable for use in the present disclosure is further described in US-A-2015028197, the contents of which are hereby incorporated by reference in their entirety.

Precursor ions accumulated in the extraction trap 140 are injected into the ToF mass analyser 150 (second mass analyser) as a packet of ions. The ions may be injected into the MR-ToF once a predetermined number of ions have been accumulated in the extraction trap 140. By ensuring that each packet of ions injected into the MR-ToF 150 has at least a predetermined (minimum) number of ions, the resulting packet of ions arriving at the detector 180 can be representative of the entire mass range of interest of the MS1 spectrum. Accordingly, a single packet of ions may be sufficient to acquire MS1 spectra of the ions.

In a third mode of operation of the tandem mass spectrometer 10, the ToF mass analyser 150 (second mass analyser) may be used to analyse the precursor ions in the MS2 domain.

In order to analyse the precursor ions in the MS2 domain, some of the precursor ions may be transferred from the quadrupole mass filter 70 to the fragmentation chamber 120 in a manner similar to second mode of operation discussed above. The precursor ions to be transferred may be mass selected by the quadrupole mass filter 70 to include targeted precursor ion species, or a m/z subrange of interest.

The fragmentation chamber 120 is, in the tandem mass spectrometer 10 of FIG. 1, a higher energy collisional dissociation (HCD) device. A collision gas may be supplied to the fragmentation chamber 120. When precursor ions are to be fragmented, the kinetic energy of the precursor ions may be increased, so that precursor ions arriving at the fragmentation chamber 120 and colliding with collision gas molecules results in fragmentation of the precursor ions into fragment ions.

Although an HCD fragmentation chamber 120 is shown in FIG. 1, other fragmentation devices may be employed instead, employing such methods as collision induced dissociation (CID), electron capture dissociation (ECD), electron transfer dissociation (ETD), photodissociation, and so forth.

Fragmented ions may be ejected from the fragmentation chamber 120 at the opposing axial end to the C-trap 100. The ejected fragmented ions pass into the second transfer multipole 130 and into the extraction trap 140 where they are accumulated. The fragmented ions may then be injected into the ToF mass analyser 150 as described above.

In another mode of operation, ion fragmentation may occur within a high-pressure region of the extraction trap 140 (instead of in the fragmentation chamber 120).

In another mode of operation, the orbital trapping mass analyser 110 (first mass analyser) may be used to analyse the precursor ions in the MS2 domain. Fragment ions may be passed back from the fragmentation chamber 120 to the C-trap 100 and ejected therefrom into the orbital trapping mass analyser 110 for mass analysis.

It will be appreciated that in some embodiments, the first mass analyser (orbital trapping mass analyser 110) and the second mass analyser (ToF mass analyser 150) may be operated concurrently. That is to say, it will be appreciated that the tandem mass spectrometer 10 may be operated in a first (or other) mode of operation concurrently with the second or third (or other) mode of operation.

The tandem mass spectrometer 10 may be under the control of a controller which, for example, is configured to control the timing of ejection of the trapping components, to set the appropriate potentials on the electrodes of the quadrupole 70, and so on, so as to focus and filter the ions, to capture the mass spectral data from the orbital trapping mass analyser 110 and the ToF mass analyser 150, control the sequence of MS1 and MS2 scans and so forth. In other words, each of the components of the tandem mass spectrometer 10 may be controlled by a controller (not shown). The controller may comprise a computer that functions as a data processor for receiving data from a mass analyser, the data representative of the quantity of mass analysed or detected ions from a mass analyser. The computer may also function as a data processor for processing the data to provide a mass spectrum and/or quantitative analysis of the ions. The controller may further comprise a display and user input device so that a user can view and enter or select information. The user input device may be a keyboard and/or a mouse. It will be appreciated that the controller may comprise a computer that may be operated according to a computer program comprising instructions to cause the (ion) analytical instrument or (tandem) mass spectrometer to execute the steps of the method according to the present disclosure.

In embodiments where the sample molecules may be supplied from a chromatographic separation device such as (for example) an LC column, the methodology according to the present disclosure may acquire data about the sample over a duration corresponding to a duration of one or more chromatographic peaks of the sample supplied from the chromatographic separation device (LC column). As such, the controller may be configured to perform an analysis cycle in accordance with an embodiment of this disclosure over the duration of a chromatographic peak. In some embodiments, the analysis cycle according to embodiments of this disclosure may be repeated a plurality of times as the sample elutes from the chromatographic separation device (LC column).

It is to be understood that the specific arrangement of components shown in FIG. 1 is not essential to the methods described herein. Indeed, other arrangements for carrying out the methods of embodiments of the present disclosure are suitable.

The tandem mass spectrometer may implement any appropriate method (including, but not limited to, those discussed above) for determining an ion current (or equivalently, an ion flux). For example, a charge detector, orbital trapping mass analyser or time-of-flight analyser may provide ion current measurements. Ion population control parameters may be determined for any of the ion trapping regions, fragmentation regions or mass analysers.

As noted above, the mass spectrometer 10 may have multiple modes of operation. Components of the mass spectrometer 10 may also have multiple modes of operation. For example, the ToF analyser 150 may be operated in a “normal” mode of operation, whereby ions are injected from the ion injector 140 into the space between the ion mirrors 160, 162 of the analyser. The ions may be reflected in one of the ion mirrors 160 and may then travel to the deflector 170 arranged between the ion mirrors at a first end of the ion mirrors. The ions may then adopt a zigzag ion path having plural reflections between the ion mirrors 160, 162 in the first direction X whilst: (a) drifting along the drift direction Y from the deflector 170 towards a second end of the ion mirrors, (b) reversing drift direction velocity in proximity with the second end of the ion mirrors, and (c) drifting back along the drift direction Y to the deflector 170. The ions may then be caused to travel from the deflector 170 to the detector 180 for detection.

The ToF analyser 150 may also operate in a mode in which the deflector 170 mounted between the mirrors 160, 162 is switched to a trapping mode, and the incoming ions are reflected to make additional passes around the analyser before being released. This may be referred to as a “zoom” mode of operation (since the analyser 150 in effect “zooms in” on a narrower m/z region of the m/z spectrum). The article A. Verenchikov, et al., Journal of Applied Solution Chemistry and Modelling, 2017, 6, 1-22, describes this zoom mode of operation. The zoom mode of operation may be used as part of the AGC or ion current determination strategy, as will be discussed in further detail below.

The zoom mode will now be described with reference to FIG. 2. In the zoom mode, ions are caused to complete a plurality of cycles within the ToF analyser 150, wherein in each cycle, the ions drift in the drift direction Y from the deflector 170b towards an opposite (second) end of the ion mirrors 160, 162 and then back to the deflector 170b. The zoom mode may therefore also be referred to as a multiple cycle or plurality cycle mode (in contrast to the “normal” ToF analyser mode, in which ions complete a single cycle while completing a plurality of reflections between the ion mirrors 160, 162 and are then detected by the detector 280 after the single cycle).

In each cycle, the ions also complete a plurality of reflections between the ion mirrors 160, 162 in the first direction X. Thus, in each cycle, the ions adopt an oscillating path between the ion mirrors 160, 162. After the ions have completed an initial cycle, each further cycle is initiated by the deflector 170b to reverse the drift direction velocity of the ions (in proximity with a first end of the ion mirrors 160, 162). This may be effected by applying an appropriate voltage to the deflector 170b that causes ions to leave the deflector 170b with a drift direction velocity opposite to the drift direction velocity with which the ions originally entered the deflector 170b. In other words, a vector component of the initial drift direction velocity may be antiparallel to a vector component of the exiting drift direction velocity (for example, in the Y direction). The voltage may be applied during a time period in which it is expected that the ions will arrive back at the deflector 170b. Suitable deflection voltages to reverse the drift direction of the ions may be on the order of hundreds of volts.

The deflector 170b may be used to reverse the drift direction velocity of the ions one or more times. The method may thus comprise causing the ions to complete a plurality of cycles within the analyser 150, where the first cycle is initiated by injecting the ions into the space between the ion mirrors, and after the ions have completed the first cycle, each further cycle may be initiated by using the deflector 170b to reverse the drift direction velocity of the ions.

After the ions have completed the desired number of cycles within the ToF analyser 150, the ions are allowed to travel from the deflector 170b to the detector 280 for detection. This may be implemented by removing the voltage from the deflector 170b, or an appropriate voltage may be applied to the deflector 170b, such that the ions are caused to exit the deflector 170b in a direction towards the detector 280. The ions may be reflected by one of the ion mirrors 160, 162 before travelling to (and being detected by) the detector 280.

The zoom mode of operation has the effect of increasing the length of the ion path taken by ions within the ToF analyser 150, which may increase the resolution of the analyser. Although the zoom mode may come with a moderate cost to ion transmission, any cost to ion transmission can be corrected for by a correction factor.

As shown in FIG. 2, ions may be injected from the ion trap source 240, through a deflector 170a and between the mirrors at a relatively high angle. After the first half oscillation, ions pass a second prism shaped deflector 170b that may reduce the injection angle by almost half. Oscillating ions then drift up the elongate mirror length and are turned back—for example, by the set tilt of the mirrors 160, 162 in the case of the analyser 150 of FIG. 1. By the time ions return to this second deflector 170b the voltage may be switched from an injection/extraction potential of approximately −150V to a trapping potential of approximately +350V, which reflects the ion beam back into the analyser body for a second pass. After a desired number of passes have been traversed by the ions, the deflector 170b is switched back to the injection/extraction potential and ions escape to the detector 280.

In another mode of operation, the deflector 170b may also be set so that newly injected ions are extracted to the detector 280 without passing through the length of the analyser 150. This mode may be termed a “single turn” or “single oscillation” mode, since ions only make a single oscillation between the mirrors 160, 162 (in typical operation modes, ions may make more than 20 oscillations between the mirrors 160, 162). As used herein, an oscillation between the ion mirrors 160, 162 in the first direction X should be understood as meaning that ions are reflected once by each of the first and second ion mirrors 160, 162. That is, in a single ion oscillation between the ion mirrors, ions experience two ion mirror reflections.

Analysing ions in the single ion oscillation mode of operation may comprise injecting ions from an ion injector or ion source 140 into a space between the ion mirrors 160, 162, wherein the ions are reflected by the first ion mirror 160, travel to the deflector 170b or a lens, and are then caused to travel from the deflector 170b or the lens to the detector 280 via a reflection in the second ion mirror 162.

The single turn mode typically benefits from high ion transmission and few losses due to collisions with background gas, which may be useful for ion population measurement. The single turn mode also has a fast operation time.

In the ToF analyser 150, the number of oscillations per pass is tuneable based on an injection angle and stripe electrode potential.

As discussed above, AGC is an important feature in (ion) analytical instruments, including in the tandem mass spectrometer 10 illustrated in FIG. 1 and discussed above, for example. It will be appreciated that the AGC methods discussed herein may be implemented in other analytical instruments for ion analysis or other mass spectrometers. For instance, automatic gain control may be implemented in an ion mobility spectrometer, an ion detector or ion spectroscopy applications. Any one of these instruments may experience negative effects resulting from over accumulation of ions (for example, space charge effects or saturation) that can be prevented or reduced through automatic gain control.

In particular, it is generally desirable to optimise the ion population admitted to a mass analyser or ion processing region. This may allow saturation effects from overall population or individual intense species to be prevented or reduced, but may also allow wasted ion beam time to be minimised. For example, a peptide MS/MS scan may require around 5000 ions to be able to confidently identify the peptide. If the number of ions can be provided in, for example, 5 ms of beam time, utilising a longer accumulation time (for example, 10 ms) is inadvisable, even if there is little chance of saturation effects. In particular, the additional (for example, 5 ms) beam time may be better used for a subsequent scan. Thus, the ion population is typically controlled by setting a pre-programmed ion target (5000 ions in the example discussed above), and the accumulation time controlled based on data from an ion current (or, equivalently, ion flux) measurement.

The basic premise of AGC is that the ion flux entering the instrument does not change significantly (or changes in a predictable manner) in the time between taking data acquisitions that are closely spaced in time, and so a target accumulation time for an acquisition Aᵢ can be predicted from a previous acquisition A₀. Although this method is most useful for trapping-type instruments, such as for example quadrupole ion traps (QITs), orbital trapping mass analysers, and Penning traps, non-trapping instruments such as, for example, time-of-flight mass analysers may also control a parameter based on previous acquisition(s) to attenuate an ion beam, thereby increasing dynamic range. In another example, a duration of a measurement time may be controlled based on previous acquisition(s). For example, a quadrupole time-of-flight (qToF) mass analyser may, instead of accumulating ions, accumulate a plurality of shots over a period of time, wherein the period of time is adjusted based on the previous acquisition(s).

For a trapping instrument, the known AGC methods may estimate an accumulation time for Aᵢ using the following Equation 1, where tᵢ and t₀ are accumulation times for Aᵢ and A₀ respectively, I₀ is an intensity value proportional to ions from A₀, and I_{target} is a target intensity value for Aᵢ.

$${t}_{i} = \frac{{N}_{target}}{F} = \frac{{t}_{0}}{{I}_{0}} {I}_{target} \qquad ( 1 )$$

In the above equation, the quantity N_{target} is a desired or optimal population of ions in the trap and F is the incident ion flux (in number of ions per second). However, an ion current may be used in an equivalent manner to calculate the accumulation time tᵢ instead of an ion flux.

It is possible to use the acquisition A₀ to estimate the abundance of several analyte species at once, so that acquisitions Aᵢ (i=1, 2, . . . n) all use intensity information from A₀. In such a scenario, A₀ might use an instrument mode that allows analytes over broad range of mass-to-charge to be transmitted, while Aᵢ would be targeted for a specific analyte or set of analytes, in a selected ion monitoring (SIM) or MS2 instrument mode.

Although the basic premise of AGC may be used with sufficient accuracy for specific experiments, various advances in AGC have been made. These include the use of a different (often faster or more efficient) mass analyser for the ion current measurement (for example, as described in U.S. Pat. No. 7,880,136 B2) or using a different ion or current detector (which is described in U.S. Pat. No. 11,087,969 B2, for instance) to augment flaws in the mass spectrometric current determination. For example, an orbital trapping mass analyser may suffer from difficulties with the population determination of multiply charged ions (particularly when the ions are highly multiply charged). This is due to the destructive interference of an induced image current signal, which is caused by closely spaced isotopes. Determining the ion current or ion flux using a second detector (which may be an electrometer or ion trap analyser, for example) allows for more reliable population control.

Compensation factors may be used to account for differences between different types of mass analyser. These differences may include transmission differences, m/z range differences and/or differences in definitions of ion intensity. For instance, transfer efficiencies between the two or more mass analysers may depend on various instrument parameters (for example, RF frequencies applied to one or more sections of the instrument). These efficiencies may be measured as a function of parameter settings to account for the transmission differences, for example, as described in U.S. Pat. No. 9,202,681 B2. The mass-to-charge ratio of ions to be detected may be treated as an instrumental parameter, since the mass-to-charge ratios vary with varying instrumental settings. In another example, a transfer function for converting measured intensity in a first mass analyser to an intensity in the target units of a second mass analyser, as described in U.S. Pat. No. 9,202,681 B2 (for instance) may be used. This is because not all mass analysers may output intensity values in units of ions per second.

AGC is also compatible with filling two accumulation regions in sequence (for example, a primary and auxiliary accumulation region) to improve the duty cycle at high throughput, in which the availability of the accumulation region may be restricted by the time required for ion processing.

In predictive AGC, a full mass scan (also known as MS1) is used as a pre-scan to determine accumulation times for a series of ion fragmentation MS2 (also known as MS/MS) scans. This removes the need to perform time consuming pre-scans for each MS2 acquisition. Adjustments may be made to account for difference in ion transmission between the broad mass range of the MS1 scan and the isolated ion MS2 scan. This is discussed in U.S. Pat. No. 8,552,365 B2, for example.

For Data Independent Acquisition (DIA) methods, in which an analytical instrument cycles through a series of fixed MS/MS scans, a previous MS/MS scan may serve as a pre-scan for an injection. This is advantageous as full mass range pre-scans or full MS scans may not contain sufficient ions of a low lying species for determination of its ion current or ion flux. However, one issue is that the ion current or ion flux is normally time dependent. For example, many methods involve admission of sample eluted from a chromatographic separation device such as, for example, an LC column, and the previous matching scan may have been performed a significant amount of time prior. One method for addressing this issue, as discussed in co-pending U.S. patent application Ser. No. 17/745,780 and European Patent Application No. 23170080.8, may comprise predicting a next detection point to be acquired in an elution profile (for example, a total ion current) based on a set of historic detection points (for instance, a set of most recent detection points). The predicted next detection point may be determined by applying the set of historic detection points to a machine learning model that was trained to determine a predicted next detection point. The accumulation time for the next acquisition may be set based on the intensity of the predicted next detection point. For example, the accumulation time for a next acquisition may be determined as the target number of ions to be accumulated divided by the predicted ion flux of the next acquisition.

Whilst it is possible to control the number of ions in a packet of ions by controlling an accumulation time, it is also possible to do so by controlling ion currents or ion fluxes or by attenuating an ion population. This may be achieved by isolation, reducing ionization efficiency or transmission efficiency, or another method, for example. Isolation may involve applying dual resonance frequencies to a linear ion trap, wherein one frequency is set to eject ions of an m/z range higher than the target ion, and the other frequency is set to eject ions of an m/z range lower than the target m/z.

Attenuation may be achieved in a m/z dependent manner, so that excessively intense species may be reduced without harming transmission of low abundance analytes. This is discussed in U.S. Pat. No. 10,930,482 B2, for example. Attenuating the population in an m/z dependent manner may be useful, since space charge effects may arise not only as a consequence of overall ion population, but also due to resonant effects between large ion populations of similar m/z. U.S. Pat. No. 7,960,690 B2A describes the use of a high frequency ion gate with an applied waveform, capable of achieving a proportional reduction in ion transmission without the need for highly accurate timing control. This is useful when incoming ions are not contained in a uniform beam, which may be the case when ion packets are released by an upstream ion mobility separator, for example.

In summary, there exists a wide range of developed strategies for carrying out ion population control, particularly for hybrid instruments incorporating more than one mass analyser. Each strategy may have its own advantages and disadvantages. For example, pre-scans in an orbital trapping mass analyser may be low resolution and may be produced with a minimum ion signal, so may generally be unsuitable for any other analytical purpose. Furthermore, the orbital trapping mass analyser pre-scans may require a considerable time investment.

In another example, MS1 scans may have too short an injection time to determine populations of low intensity ions for prediction of an ion current or ion flux for an MS2 scan.

In a further example, in DIA methods, MS2 predictions based on an MS2 scan may require a fast cycle time to be able to outpace the peak elution time (the time duration over which a typical chromatographic peak elutes) of liquid chromatography. This may cause issues in short LC gradient and/or high throughput experiments.

In another example, ion trap pre-scans (for example, supporting an orbital trapping mass analyser) can be advantageous due to their high scan rate and consistent high sensitivity. However, these pre-scans generally deliver low resolution peaks that may otherwise not be widely useful.

Some of these disadvantages may be partially addressed by the methods discussed above (for example, the use of a different ion or current detector to augment flaws in the mass spectrometric current determination). However, present instruments are only capable of implementing one particular AGC method, based on their components and (pre-) programming, which means that the various disadvantages cannot be addressed in a dynamic manner. For example, whilst it may be possible to program the (ion) analytical instrument to implement more than one particular AGC method, it has not previously been possible to switch between the methods extemporaneously and/or select or determine an appropriate AGC method extemporaneously. Furthermore, whilst a pre-scan (or another standard analytical method) may generate large amounts of usable ion current or ion flux data, this information is essentially discarded after use. For instance, not all of the data may be required for the implemented AGC method and a new pre-scan may be performed for a new directly subsequent MS1 scan. Thus, full use of the pre-scan information (which may require significant time to obtain) is not necessarily made. As such, previous control methods for determining optimal AGC strategies extemporaneously, switching between different AGC strategies, and/or combining data from multiple AGC methods are lacking.

The inventors have recognised that separate AGC methods may be utilised together and/or switched between extemporaneously, whilst also making greater use of the large amounts of generated data (which may include ion current and/or ion flux data). This may be achieved by the use of stored data. In particular, rather than utilising only the most recent ion current or ion flux data (as is the case in current analytical instruments), data comprising a plurality of signals and respective one or more operating parameters associated with the plurality of signals may be stored for use. Thus, an optimal automatic gain control strategy can be determined based on the most appropriate data (for example, the most similar previous scan) to enable more accurate ion current estimations and/or the provision of more accurate automatic gain control. This may in turn improve accuracy of results obtained by an analytical instrument. Switching between various AGC strategies is also enabled, which may also improve the accuracy of the results obtained. In short, a more universal method for ion current (or, equivalently, flux) estimation and/or AGC is provided, as well as a more straightforward method of enabling AGC for complex hybrid AGC methods. Furthermore, greater use can be made of data that would otherwise be discarded, since data from each scan can be stored and later utilised.

Each of the plurality of signals is representative of an ion current (or equivalently, an ion flux) obtained using a respective analytical instrument configured to operate according to the respective associated one or more operating parameters. The analytical instrument may be used for ion analysis but may include components prior to ionisation (for example, an LC detector), and so may be referred to herein generally as an analytical instrument. The stored data may be stored in a database, which may be in communication with a first (ion) analytical instrument. The communication may be a direct link (for example, a wired connection) or the communication may be via a (wired or wireless) network. In other words, a system comprising a first analytical instrument and a database is provided. The first analytical instrument may comprise the database.

The first analytical instrument is configured to be operated according to one or more first operating parameters and controlled based on an estimated ion flow parameter. The ion flow parameter is estimated by selecting at least one signal from the stored data based on the one or more first operating parameters. The at least one selected signal is used to estimate the ion flow parameter when the first analytical instrument is controlled.

The scan history information or ion current (ion flux) information may also be used to control the (ion) analytical instrument in other manners. For instance, the ion current information may be used to exclude target m/z ranges if, for example, there are m/z subranges in which there are relatively few ions (for example, fewer than 5000 ions for the maximum injection time). In another example, the controller could implement one or more rules to widen an m/z range (for example, for a quadrupole) to admit more ions. In a further example, the controller could be programmed to allow overload of ion accumulation time beyond the usual maximum if the scan history information indicates one or more m/z subranges having relatively few ions. A longer maximum accumulation time in combination with a wider m/z window may allow for the same overall cycle time. Thus, duty cycle time may be maintained. Other use of the ion current information is possible. For example, a signal accumulation time period or measurement time period for a detector may be controlled based on the ion current (ion flux) information. Downstream software processing may be used to handle chimeric spectra.

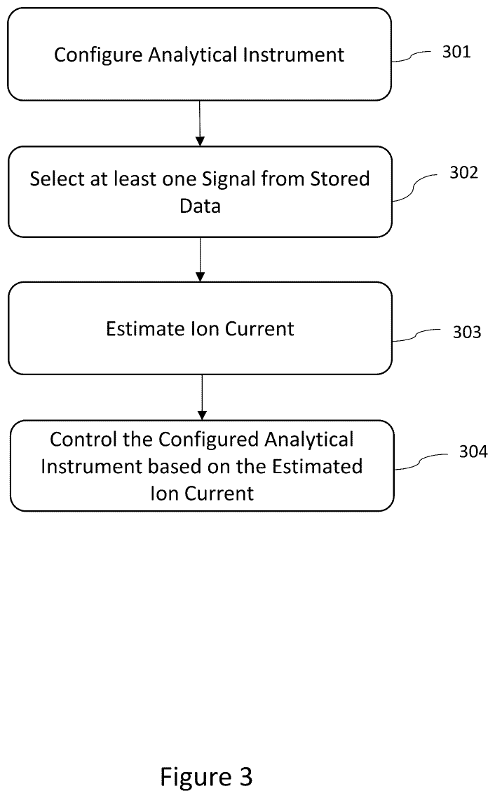

With reference to FIG. 3, there is provided a flowchart of a method for operating a first (ion) analytical instrument. The method may be used in the tandem mass spectrometer 10 illustrated in FIG. 1, but it will be appreciated that the method may be implemented with other analytical instruments.

In step 301, the first (ion) analytical instrument is configured to be operated according to one or more first operating parameters. The one or more first operating parameters may comprise operating parameters of the analytical instrument. For example, the one or more first operating parameters may comprise or define an operation mode of the first (ion) analytical instrument. In one example, the one or more first operating parameters may define that the first (ion) analytical instrument is to be controlled such that a first mass analyser (for example, an orbital trapping mass analyser) performs an MS1 scan and a second, different mass analyser (for example, a ToF mass analyser) performs an MS2 scan. This may correspond to operating the first and third modes of operation of the tandem mass spectrometer 10 discussed above.

The one or more first operating parameters may also or instead comprise a mass-to-charge ratio and/or mass-to-charge ratio range. The mass-to-charge ratio (range) may comprise a mass-to-charge ratio (range) for one or more components of the analytical instrument. For example, the mass-to-charge ratio range may be a scan range for a mass analyser. The scan range may include more than one range—for example, a wider MS1 range for a mass filter upstream of, for example, an orbital trapping mass analyser or another type of mass analyser and a narrower MS2 range for a mass filter upstream of the orbital trapping mass analyser or a different type of mass analyser. In another example, the mass-to-charge ratio (range) may also or instead be mass-to-charge ratio values for trapping in or guiding through a component of the mass spectrometer, for example. The component may be an ion trap or an ion guide, for instance. In a further example, the mass-to-charge ratio (range) may be a mass-to-charge ratio (range) to be filtered by a mass filter. As the mass-to-charge ratio (range) may be applied to one of any number of components of the first (ion) analytical instrument, the mass-to-charge ratio (range) may be considered as a component operating parameter. In a further example, the one or more operating parameters may additionally or alternatively specify a target number of ions. The target number of ions may be a target number of ions to be accumulated in an ion trap, a number of ions in an ion beam (for example, for beam attenuation) and/or a target number of ions in a peak detected when controlling the first (ion) analytical instrument. The one or more operating parameters specifying a target number of ions in a detected peak may be useful for preventing or limiting space charge effects, which may also occur if the ion population of a detected peak (for example, the most intense peak) is high. As the target number of ions may be a target number of ions in an ion trap (or another suitable component of the first (ion) analytical instrument), the target number of ions may be considered as a component operating parameter.

Additionally or alternatively, the one or more operating parameters may comprise at least one parameter for implementing a fragmentation method and/or information regarding the fragmentation method. The fragmentation method may include no fragmentation. For example, the one or more operating parameters may configure the analytical instrument to prevent collision gas from entering a fragmentation chamber (for example, by closing a gas valve) or remove the collision gas from the fragmentation chamber (for example, by opening an aperture in the fragmentation chamber to allow the gas to escape). In another example, the one or more operating parameters may be used to configure the analytical instrument or fragmentation chamber such that the energy of the precursor ions is insufficient to fragment the precursor ions when they collide with the collision gas. For example, a RF and/or DC potential may be applied to the fragmentation chamber or another section of the analytical instrument that does not provide sufficient kinetic energy to the ions for fragmentation. In an example, the one or more operating parameters may further comprise a fragmentation energy. The fragmentation energy may be a collision energy. The collision energy may define an RF and/or DC potential to be applied to the collision cell or another section of the analytical instrument. As the fragmentation method and/or collision energy may be dependent on a component of the first (ion) analytical instrument (for example, the fragmentation chamber), the fragmentation method and/or collision energy details may be considered as component operating parameters.

Additionally or alternatively, the one or more operating parameters may define an ion path through the first (ion) analytical instrument. For example, the one or more operating parameters may determine which sections of the first (ion) analytical instrument that the ions pass through and/or in which order the ions pass through the sections. For example, the operating parameters may define that ions are to be analysed in the MS1 domain by a first mass analyser and/or analysed in the MS2 domain by a second, different mass analyser.

In one example, the one or more operating parameters may additionally or alternatively define a path length through a mass analyser. For example, the one or more operating parameters may define a path length through a ToF analyser.

As discussed above, one or more of the one or more first operating parameters may be component operating parameters of at least one component of the first (ion) analytical instrument. The component may be any one or more of the components discussed above (for example, in respect of the tandem mass spectrometer 10 illustrated in FIG. 1). The component may be, for example, a mass analyser, an ion guide, an ion gate, a mass filter, a fragmentation cell, an ion source, an ion trap, a detector, and so on.

The operation mode of the first (ion) analytical instrument may thus comprise or define a component operation mode. For instance, the operation mode may specify that a ToF analyser 150 is operated in a normal mode, a single oscillation mode or a zoom mode. In another example, the operation mode may specify whether a section or component of the first mass analyser is to transmit or trap ions (in other words, whether a transmitting or trapping potential is applied to the section). In a further example, the operation mode may specify a type of scan of a mass analyser (for example, MS1, MS2 or MSn). In other words, the operation mode may specify in which domain analysis is performed.

Additionally or alternatively, the one or more first operating parameters or component operating parameters may comprise a type of mass analyser. For example, the component operating parameters may specify that the type of analyser comprises a Fourier Transform mass analyser and/or time-of-flight mass analyser. The component operating parameters may more specifically define that an orbital trapping mass spectrometer 110 and/or an ToF analyser 150 is to be used. In another example, the one or more operating parameters may specify that a multipole (for instance, quadrupole) mass analyser is to be used. In yet a further example, the mass analyser may comprise a Fourier Transform Ion Cyclotron Resonance (FT-ICR) mass analyser. The one or more first operating parameters may specify another type of mass analyser.

Additionally or alternatively, the one or more first operating parameters or component operating parameters may comprise an amplitude and/or frequency of one or more RF and/or DC potentials to be applied to one or more sections of the first (ion) analytical instrument. When applied, the RF and/or DC potentials may, for instance, cause a component of the analytical instrument to transmit, store, accumulate and/or trap ions within the one or more sections. The one or more sections may comprise any one or more of: an ion guide, an ion gate, an ion source, an ion store, a mass analyser and/or another component.

The one or more first operating parameters or component operating parameters may additionally or alternatively specify a detector type and/or measuring instrument of the first (ion) analytical instrument. The detector may comprise an ion detector, for instance. The detector may be an electron multiplier, faraday cup, image current detector, multi-channel plate or another detector, for example. In another example, the detector may be an electrometer. In a further example, the detector may comprise an LC detector (for instance, in a LC-MS system). The LC detector may comprise an ultraviolet (UV) or ultraviolet-visible light (UV-Vis) absorption detector, which may be a variable wavelength detector (VWD), a diode array detector (DAD) or a multiple wavelength detector (MWD). Additionally or alternatively, the LC detector may comprise a fluorescence detector, an evaporative light scattering detector (ELSD), a refractive index detector, an electrochemical detector (ECD) and/or a charged aerosol detector (CAD). The one or more operating parameters may comprise more than one type of detector. In an LC-MS system, for example, an LC detector and an ion detector may be used.

Although the use of various first operating parameters and/or component operating parameters has been discussed above in respect of step 301, it will be appreciated that any other appropriate operating parameters may be used to control the first (ion) analytical instrument.

In step 302, at least one signal is selected from stored data comprising a plurality of signals and a respective one or more second operating parameters associated with each of the plurality of signals. Each signal of the plurality of signals is representative of an ion current (ion flux) obtained using the first (ion) analytical instrument configured according to the respective associated one or more second operating parameters or a one or more second (ion) analytical instrument configured according to the respective associated one or more second operating parameters. A signal representative of an ion current (ion flux) may include an ion current, a voltage, an ion (intensity) peak, or another measurement indicative of an ion flux.

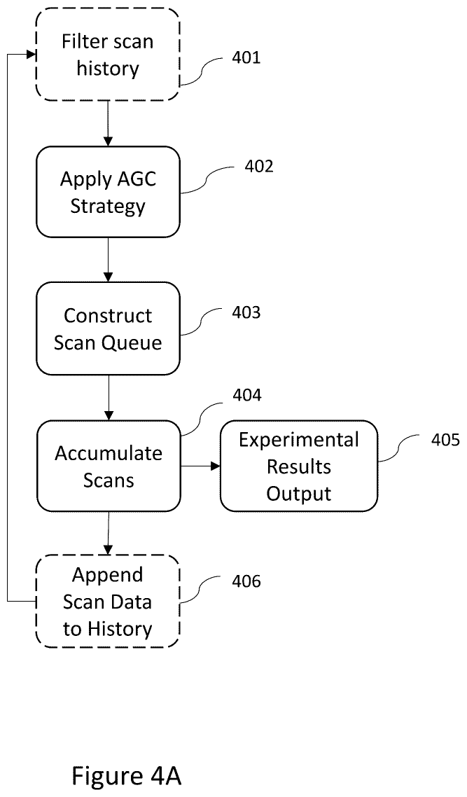

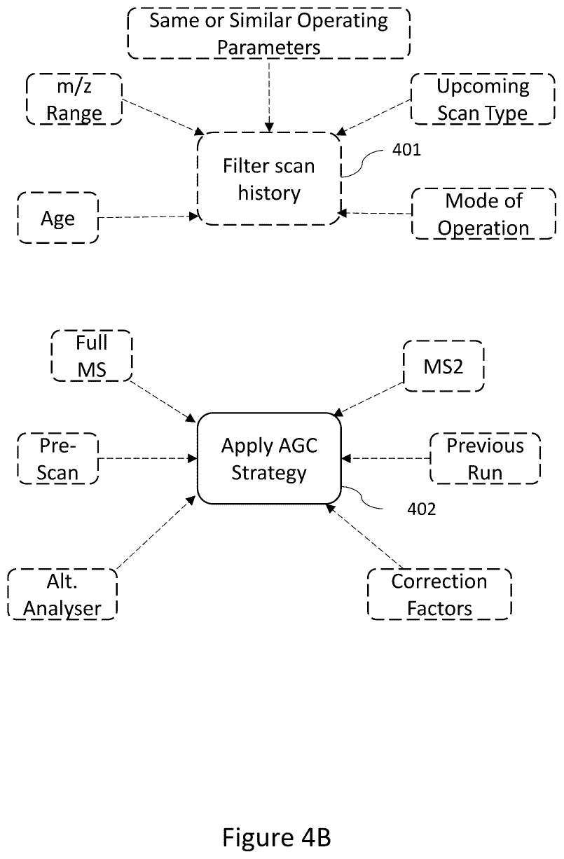

In some examples, the one or more second analytical instruments may be optional. In other words, each of the signals may be obtained using the first analytical instrument. In other examples, each of the signals may be obtained using the one or more second analytical instruments. That is, the stored data may not include any signals associated with the first analytical instrument. In this case, it may be particularly useful to store data obtained during the controlling of the first analytical instrument (step 304), as will be discussed with reference to FIG. 4 (step 406). In yet further examples, the stored data may include at least one signal obtained using the first analytical instrument and at least one signal obtained using the one or more second analytical instrument.

When present, the one or more second analytical instruments is/are a different instrument to the first analytical instrument. However, at least one of the one or more second analytical instruments may nevertheless be the same type of analytical instrument as the first analytical instrument. Accordingly, at least one of the plurality of signals may have been obtained using the same type of instrument that will be controlled according to the estimated ion current. However, the plurality of signals need not each have been obtained by the same or same type of analytical instrument. For example, some of the plurality of signals may have been obtained by different mass spectrometers of the same type or by different types of mass spectrometer. In one example, at least one of the one or more second analytical instruments and the first analytical instrument may be different types of analytical instrument. In another example, one or more of the one or more second analytical instruments may be different types of analytical instrument. A different type of analytical instrument may mean that different components are present in one analytical instrument compared to another. For example, one analytical instrument may comprise a ToF analyser and a Fourier Transform mass analyser and another analytical instrument may comprise a quadrupole mass analyser. In other words, the stored data may be received from one or more sources.

The one or more second operating parameters associated with the respective signal may comprise any one or more of the type of operating parameters discussed with reference to the first operating parameters (step 301). The selection in step 302 is based on the one or more first operating parameters, as will be discussed in further detail below. However, the respective one or more second parameters need not be the same as the first operating parameters. The selection may comprise (or be proceeded by) a step of applying one or more filtering criteria to the stored data to obtain a subset of data, the subset of data comprising the at least one signal and the respective one or more second operating parameters. The step of applying one or more filtering criteria will be described in more detail with reference to FIGS. 4A and 4B.

One or more factors may be weighted or otherwise balanced to select the signal in step 302. For example, when an upcoming MS2 scan on a particular analytical instrument is to be performed, if an MS2 scan on the same type of analytical instrument (for example, comprising the same type(s) of mass analyser) performed less than a threshold amount of time prior is available, ion current or ion flux prediction may be carried out using the prior MS2 scan. However, if a previous MS2 scan is not available or, for example, the MS2 scan was performed more than a threshold amount of time prior, a more recent MS1 scan may be used instead. A score may be calculated based on a weighting of the one or more factors, and the signal selected based on the score.

Data from one scan may be used to assess whether other scans are suitable. For example, frequent MS1 scans may show a sudden shift in ion signal. In this case, a prior MS2 scan may be disqualified as an information source, for example, because of the long MS2 cycle time. One use of frequent MS1 scans will be discussed below with reference to FIG. 6.

A special case exists for DIA MS2 scans having overlapping m/z windows. The overlapping region from a previous scan may be used to more accurately predict the ion population in that part of the successor scan. A previous cycle or prediction from MS1 may be required to predict the ion population for the non-overlapping region, or another measurement may be used to provide information for predicting the ion population for the non-overlapping part of the m/z window. This is one way in which an AGC strategy may use more than one method per scan, which may be split between differing m/z ranges or injections (for example, if multiple ion accumulation periods are used with differing parameters). As noted above, the results of differing methods may also be combined by averaging and weighing.

In some embodiments, the selection may be a pre-determined preference. For example, MR-ToF MS1 scans may generally be given preference over MS1 scans by an orbital trapping mass analyser as a predictive tool for either analyser. Correction factors may be used to account for differences in transmission (as an MR-ToF may be up to twice as sensitive by this measure) and to match intensity reporting. Corresponding (the same or similar) scan types are also given preference, though compensation factors may also be used to account for differences in transmission between scan settings—for example, with regards to ion source RF settings, quadrupole isolation widths, or another setting.

The AGC strategy may also be adjusted based on detected analytes, such as highly multiply charged ions, for example. Orbital trapping mass analysers may be less adept at ion population determination for highly multiply charged ions, so may be less prioritised for signal selection, for instance.

The selection in step 302 may comprise using an algorithm, a graph, a mathematical model or a machine learning model to select the at least one signal. For example, the controller may implement a decision tree (a flowchart-like structure), or more complex strategies, such as a model constructed by a supervised learning algorithm, for example. A supervised learning algorithm may search through a hypothesis space to find a suitable hypothesis that can make accurate predictions with a particular problem. Supervised learning algorithms include support-vector machines, linear or logistic regression, naïve Bayes, decision trees, k-nearest neighbour algorithm, neural networks and similarity networks. A multiple classifier or ensemble method (which use multiple learning algorithms or hypotheses) may improve the accuracy of the results. For example, a random forest (random decision forest) is an ensemble learning method that operates by constructing a multitude of decision trees at training time. Unsupervised learning algorithms, such as clustering methods, anomaly detection methods and/or approaches for learning latent variable models, for example, may also or instead be used. Clustering methods may include hierarchical clustering, k-means, mixture models, DBSCAN and OPTICS algorithm. Anomaly detection methods may include local outlier factor and isolation forest methods. Approaches for learning latent variable models may include an expectation-maximisation algorithm, method of moments and blind signal separation techniques. Weak or semi-supervised learning may also or instead be used.

In some embodiments, more than one signal may be selected. For example, more than one signal may be deemed suitable based on the one or more first operating parameters. In one example, this may be due to one signal being suitable due to some of the operating parameters (for example, the one signal having been obtained on the same or same type of instrument), while another signal being suitable due to other operating parameters (for instance, having an m/z range more similar to the upcoming scan). The selection of more than one signal will be discussed in more detail with reference to FIGS. 4A and 4B.

At step 303, the ion current (or ion flux) is estimated using the at least one signal. This may be achieved using any known method of ion current or ion flux estimation.

In embodiments where more than one signal is selected, the estimating may comprise weighting the more than one selected signal to estimate the ion current (ion flux). For example, a more recent MS1 scan may be weighted more heavily in the ion current (ion flux) estimation than a less recent MS1 scan.

At step 304, the configured first (ion) analytical instrument may be operated or controlled based on the estimated ion current (ion flux). The operation may comprise performing automatic gain control based on the estimated ion current (ion flux). Automatic gain control may be implemented by comparing the estimated ion current to a target ion number (for example, as in Equation 1) for an upcoming scan or target m/z value, and an injection time may be calculated based on the estimated current to reach the target ion number. In another example, the estimated current may be used to attenuate the ion population. Attenuation may be achieved via isolation, by reducing ionisation efficiency of the ions, by reducing transmission efficiency or another method. In yet a further example, the estimated ion current may be used to control a duration of an ion measurement time.

The performing automatic gain control may comprise combining more than one AGC strategy. For example, an MS2 scan for one m/z range and another scan for another m/z range (which may include the one m/z range) may be combined to estimate or calculate a suitable injection time to obtain a target number of ions based on the estimated ion current (ion flux).

In another example, controlling the configured first analytical instrument may comprise scheduling the performance of one or more steps in an analysis, based on the estimated ion current. For example, it may be useful to perform an MS1 and/or an MS2 measurement at or near the apex of a chromatographic peak, as this may minimise the beam time required per precursor ion. The estimated ion current may thus be used to schedule the MS2 measurement to coincide (to within a threshold tolerance) with the peak. Such scheduling will be described in further detail with reference to FIG. 6. In another example, an MS1 and/or an MS2 measurement may be scheduled to occur distal from the apex of a chromatographic peak (for example, at a peak minimum). For example, an undesired peak may obscure a target material peak. It may therefore be useful to schedule an MS1 and/or an MS2 measurement away from the peak apex to reduce the signal of the undesired peak in the analytical results. In a further example, a mass-to-charge selection step, fragmentation step or another step may be scheduled based on the estimated ion current.

A method of operating a first (ion) analytical instrument in accordance with the above will now be described with reference to the tandem mass spectrometer 10 illustrated in FIG. 1, but it will be appreciated that the method may be implemented with other types of analytical instrument.

As discussed above, each of the first mass analyser (orbital trapping mass analyser 110) and the second mass analyser (ToF analyser 150) may be capable of recording full MS and/or MS2 fragmentation spectra. For example, the orbital trapping mass analyser 110 is capable of achieving high resolution MS scans, but may be relatively slow to do so. A resolving power of 240K may require a 512 ms acquisition time, for instance. Furthermore, the orbital trapping mass spectrometer 110 typically requires several ions (in other words, more than one ion) to form a detectable peak. Conversely, the ToF analyser 150 can perform much quicker analysis (for example, each scan may require no more than 5 ms) and can achieve single ion sensitivity, whilst still allowing a high resolving power (for example, in the range of 50-100K). However, space charge effects are more pronounced in the ToF analyser 150: intense peaks (which may have more than a thousand ions) can greatly reduce the resolution, and the position of mass measurements may shift in a complex manner under heavy ion loads, for instance.

In the widely used Data Dependent Acquisition (DDA) experimental scheme, an initial “survey” scan may be used to identify a number of precursor ions for further analysis in several (e.g. in the range of 10-50) subsequent “dependent” mass scans, which may comprise tandem mass spectral scans (MSn). For example, interesting features eluting from a liquid chromatograph (LC) may be identified and the subsequent mass scans performed to interrogate the precursor species identified in the survey scan. In contrast, in Data Independent Acquisition (DIA) experimental schemes, all precursor ions may be fragmented in the several subsequent scans.

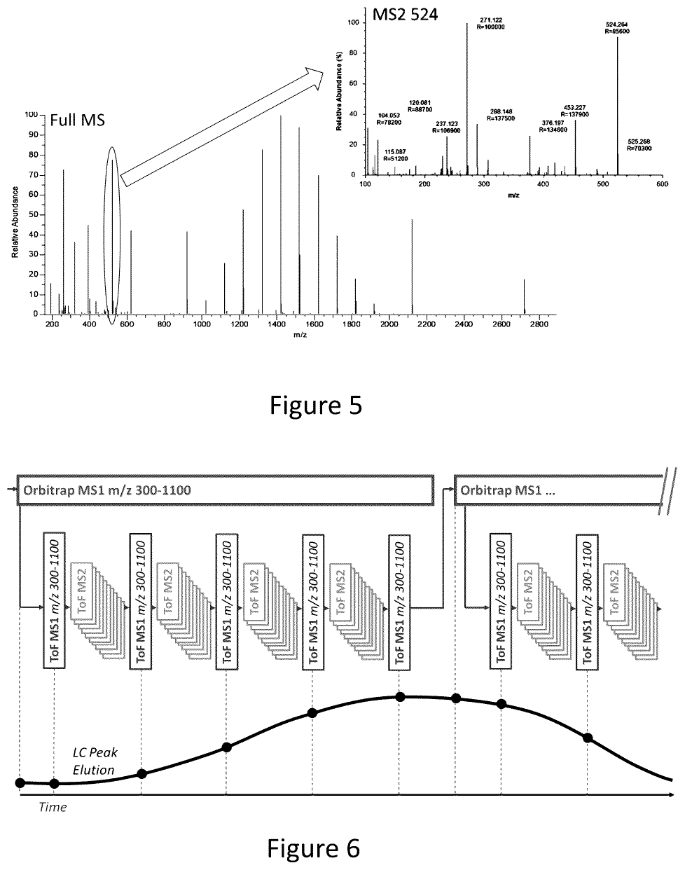

With reference to the tandem mass spectrometer 10 illustrated in FIG. 1, in typical DIA and DDA methods, the orbital trapping mass analyser 110 may be used to make a high-resolution MS1 survey scan to detect unfragmented precursors, whilst the ToF analyser 150 may perform a large number of sensitive MS2 fragment scans upon the precursor ions. An example of a full MS scan of a Pierce (RTM) FlexMix (RTM) calibration solution is illustrated in FIG. 5, with an MS2 fragment spectrum of the isolated m/z 524 MRFA peptide. An appropriate AGC strategy desirably optimises the ion loading on both analysers in their respective modes of operation (MS1 or MS2).

In accordance with the above, information obtained by the mass analysers (and/or other components of the tandem mass spectrometer 10) can be used to construct a scan history. The scan history (stored data) may contain one or more acquired mass spectra and/or information regarding one or more detected peaks. The information regarding detected peaks may comprise an intensity and/or resolution of the peaks and/or other information relating to the detected peaks. The scan history may also or instead include header data from a scan, such as m/z range, ion accumulation time, scan type (for example, MS1 or MS2), fragmentation energy, or other information, for example. When the scan history includes the complete information (intensity, resolution, etc.) of detected peaks from a scan as well as other header information, the ion current data may be mass resolved. However, the data may be binned (bucketed) to save data or otherwise limited. Binning the data may comprise dividing the data into a series of intervals and a value representative of the interval used in place of the specific data. For example, m/z values or m/z ranges may be grouped and a centre mass of the grouped data used. The stored data may additionally or alternatively comprise pre-scan data, one or more ion current measurements, data from a detector (for example, electrometer measurements or LC detector data) and/or data from previous experiments. The stored data may alternatively or additionally comprise other data.

The scan history may include data of every scan or the scan history may have a storage threshold. For instance, the scan history may include N data entries or the N previous scans, where N may be more than 100, 200, 500 or 1000. N may be equal to 700, for example. It will be appreciated that N may be any appropriate value. Furthermore, the value of N may be controllable, and may be selected by a user. The scan history may additionally or alternatively be limited by a maximum storage capacity. For instance, the scan history may be limited to a certain number of gigabytes or megabytes. Limiting the size and/or number of previous scans may allow less useful data (for example, data obtained more than a threshold amount of time prior, which may result in less accurate AGC control) to be deleted or removed. A large amount of data may also slow the selection of the at least one signal.

When additional data (for example, a new scan) is generated or obtained after a storage threshold of the stored data is reached, one or more data entries in the stored data may be deleted or overwritten to include the additional data in the stored data. The deleting or overwriting may comprise deleting or overwriting data entries or scan information stored for longer than a threshold time period. Additionally or alternatively, the deleting or overwriting may comprise deleting or overwriting one or more oldest stored data entries or scan information. Thus, information which is more likely to provide less accurate AGC due to the length of the time period since the information was obtained can be removed.

In some embodiments, the stored data may comprise a set of editable data and a set of non-editable data. Editable data may comprise any data that can be changed, overwritten, deleted or otherwise modified. Non-editable data may be read-only data. However, although generally it may not be possible to change, overwrite, delete or otherwise modify the non-editable data, it may be possible to convert between the editable and non-editable data. Thus, editable data may be selected for inclusion as non-editable data, which may be based on similar criteria as discussed below for storing data as non-editable data. Similarly, non-editable data may be determined as no longer required for long-term storage, and may be deleted, overwritten or converted to editable data. This may be the case where a more recent scan of an otherwise infrequent scan type is appended to the stored data, such that the older scan in the non-editable data may be less useful.

The deleting or overwriting may comprise deleting one or more data entries in the set of editable data, whilst retaining the non-editable data (even if the non-editable data is older than the editable data, for example). Thus, a “long-term history” can be created to store data that might otherwise be deleted or overwritten. There are circumstances where it is highly beneficial to retain scan history between runs—for example, for repeat experiments or similar experiments with similar samples, similar ion currents may typically usually occur. By retaining non-editable data for such scans, a more accurate ion current estimation can be performed, resulting in improved AGC.

The long-term history may only keep very selected scans and may allow some background information to always be present. This may allow information from highly infrequent types of scans to remain stored, even after a threshold time period has been reached, for example. Additionally, this long-term history or non-editable data may be used to control the injection time of an internal calibrant source. The long-term scan history may be a reduced set of data, rather than individual peaks of a scan. For example, the data may relate to more intense LC elutions or warnings where overfilled or underfilled scans were detected. A data acquisition workflow may thus incorporate a function whereby DDA precursors may be excluded or included based on records from one or more previous runs for ion population control.

Data may be stored as non-editable data based on a type of scan from which the data was obtained. For example, the scan type may be more generally applicable to ion estimation or AGC control methods than some others. It may therefore be selected (for example, user-selected or pre-programmed) for inclusion in the non-editable data set. Additionally or alternatively, the data may be stored as non-editable data based on an expected performance frequency of the type of scan. The controller may determine that the scan type has been performed less than a threshold number of times in a pre-determined time duration and so may determine that the data should be stored as non-editable data. That is, the controller may determine that the expected performance frequency is less than a threshold frequency. The expected performance frequency may be based on each data entry associated with the scan type, or a number of previous data entries associated with the scan type (for example, 1, 3, 5, 10 or another number of data entries prior to the most recent scan). The data may also or instead be stored as non-editable data based on a time duration since the type of scan was last performed. For example, the controller may determine that the time duration is more than a threshold time duration.

Prior to deleting or overwriting one or more entries of the editable data, it may be determined whether some of the entries data should be retained as non-editable data. The determination may be in response to the receiving the additional data or may be performed at another time. The editable data may be reviewed at regular time intervals or after a pre-determined number of scan data has been obtained, for instance. The determination may also be based on any one or more of: the type of scan, the expected performance frequency of the scan, and the time duration since the type of scan was last performed.

As used herein, scan history refers to both the long-term history (non-editable portion of data) and the short-term history (editable portion of data), which may comprise 700 scans.

The controller can use the scan history information, and its store of available AGC methods (or ion current prediction methods), to apply an AGC strategy. In one embodiment, the controller may filter of which scan(s) in the scan history are to be used in predicting the ion current, how to weight the scan information, and/or which methods to use for the calculation. Scans may be classified as either enabling accurate prediction of the ion current for the new instrument settings or not, as part of the selection process. The controller may use an algorithm, graph, mathematical model or a machine learning model to select the at least one ion current and/or apply an AGC strategy.

Referring to FIG. 4A, a flowchart method for controlling an analytical instrument based on an estimated ion current is illustrated. In step 401, the stored data may be filtered to obtain a subset of data. In other words, one or more filtering criteria may be applied to the stored data to obtain a subset of data. The step of filtering may reduce the number of data entries and/or allow only the data most relevant to an upcoming controlled scan to be considered for ion current estimation.

FIG. 4B illustrates exemplary filtering criteria that may be applied in step 401 to obtain the subset of data. For example, the filtering criteria may be based on at least one of the one or more first operating parameters and/or at least one of the one or more second operating parameters. As discussed above in respect of step 301 of FIG. 3, the one or more first and/or second operating parameters may define, for example, a type of mass analyser, an operation mode, a type of detector, and so on.

In one example, filtering the stored data based on the one or more first and/or second operating parameters may comprise filtering based on at least one of the one or more first operating parameters and at least one of the one or more second operating parameters being the same or sufficiently similar. Sufficiently similar may mean that the at least one of the one or more first operating parameters and the at least one of the one or more second operating parameters being the same to within a threshold tolerance, defined (for example, by a user, an AI or a machine learning algorithm) as being corresponding or similar, or otherwise corresponding. In one example, an m/z range of one scan being between or overlapping an m/z range of another scan may be sufficiently similar. Selecting the signal may accordingly comprise selecting a signal for which the one or more second operating parameters are most similar to the one or more operating parameters (for example, having the greatest number of same or sufficiently similar operating parameters).

In another example, the filtering criteria may also or instead be based on a number of detected ions. For instance, the one or more filtering criteria may also or instead comprise a number of ions detected. For example, scans comprising a lower number of ions may produce lower quality spectra (for example, with little to no signal), which may in turn result in lower accuracy ion current (ion flux) estimation. Thus, scans detecting fewer than a threshold number of ions (for example, 1000, 2000, 5000 or another number) may be ignored. In another example, scans detecting ions greater than a threshold number of ions (for example, 10,000, 30,000, 50,000 or another number) may be selected. A greater number of ions may provide more accurate ion current information.

In a further example, the filtering criteria may also or instead be based on a target number of ions. The target number of ions may be a target number of ions in one or more sections of the (ion) analytical instrument (for example, a mass analyser and/or ion trap). In another example, the target number of ions may additionally or alternatively be a target number of ions in a detected peak (for example, the expected greatest intensity peak). More than one target number of ions may be used to filter the stored data. Similar target numbers of ions may produce similar ion currents (ion fluxes). Thus, using the target number of ions as one of the one or more filtering criteria may enable more accurate current (ion flux) prediction. Selecting the signal may accordingly comprise selecting a signal for which the target number of ions for an upcoming scan is most similar to a previous target number of ions.

Utilising the target number of ions as one of the one or more filtering criteria may comprise setting a threshold tolerance. For instance, data indicating a detected number of ions in a previous scan is equal to the target number of ions to within a threshold tolerance (for example, 1%, 5%, 10% or another threshold tolerance) may be included in the subset of data. This may correspond to the target number of ions being similar. As an illustration, for a target number of ions of 10,000, data indicating a detected number of ions of 10,000+T, where T is the threshold tolerance (which may be a percentage or an absolute value), may be included in the subset of data. In a further example, the stored data may indicate a target number of ions and the detected number of ions for the one or more operating parameters. Stored data in which the target number of ions and the detected number of ions is equal to within a threshold tolerance (for example, 1%, 5%, 10% or another threshold tolerance) may be included in the subset of data.

In yet a further example, the filtering criteria may additionally or alternatively be based on a time duration since obtaining each of the plurality of signals. For instance, the one or more filtering criteria may comprise a time duration since obtaining the at least one signal being less than a threshold amount (in other words, the age of the stored data). For instance, for an LC-coupled experiment, in which ion signals may fluctuate significantly over the course of the LC elution, older scans (for example, scans more than on the order of 1 ms old) may be filtered out of the stored data. In more stable experiments, the age of the stored data may be less significant.

In yet another example, the filtering criteria may also or instead be based on an isolation window. For instance, the one or more filtering criteria may also or alternatively comprise an at least partially overlapping isolation window. Selecting the at least one signal may accordingly comprise selecting at least one signal for which the isolation window is most similar to the isolation window for an upcoming scan. Similar isolation windows may result in similar ion current (ion flux) measurements. Thus, signals corresponding to an at least partially overlapping isolation window (which may be defined by the one or more first and second operating parameters) may enable more accurate ion current (ion flux) estimation. As the one or more first and/or second operating parameters may comprise an isolation window, the filtering criteria being based on an isolation window may be considered as at least one of the one or more first operating parameters and at least one of the one or more second operating parameters being the same or sufficiently similar.

In an additional example, the one or more filtering criteria may also or alternatively be based on a retention time. For example, the one or more filtering criteria may comprise a difference in retention time duration being less than a threshold retention time duration. The retention time may be a time period over which a sample elutes from an LC column, or time duration during which an analyte spends in the stationary and mobile phase in the LC column after injection. A retention time may depend on one or more factors including, for example, a type of column, column dimensions, a sample concentration, an oven temperature, and a flow rate of carrier gas. One or more of these factors may be included in the one or more first and/or second operating parameters (which may include component operating parameters).

The filtering criteria may be based on other information and other filtering criteria may be used. For example, the stored data may be filtered based on a particular ion species to be analysed or the presence of multiply charged ions.

Any of the filtering criteria discussed above may be combined to provide a more relevant subset of data. The applying of the one or more filtering criteria may include calculating a score to indicate an expected relevance of the data entries in the subset of data. For example, data entries more closely corresponding to the upcoming scan may be scored more highly. More closely corresponding may mean that a greater number of the one or more first operating parameters and one or more second operating parameters are the same or sufficiently similar and/or that one or more of the filtering criteria fall within a lower threshold tolerance. For example, an MS1 scan obtained by an orbital trapping mass analyser may have a greater number of operating parameters the same or sufficiently similar to an MS1 scan obtained by another orbital trapping mass analyser than an MS2 scan by a quadrupole mass analyser. The MS1 scan may therefore be scored more highly than the MS2 scan. In another example, although two MS1 scans may have detected a number of ions within a threshold tolerance (10%, for example) of a target number of ions for an upcoming scan (for example, 10,000), one of the two MS1 scans may have detected a number of ions within a lower threshold tolerance (2%, for instance) than the other (for example, being within 7% tolerance). The one of the two MS1 scans may therefore be scored more highly than the other.

Referring again to FIG. 4A, the resultant at least one signal is then used to apply an AGC strategy in step 402. The AGC strategy may be selected as described above in step 302 with reference to FIG. 3 and as illustrated in FIG. 4B For example, the ion current may be estimated from a full-MS scan or a prior matching MS2 scan. If more than one data source is deemed suitable for a scan, predictions made from the more than one data source may be combined or weighted. This may enable the disadvantages of certain scan types and/or mass analysers to be overcome by using more than one ion current to predict a future ion current. Similarly, the advantages of different scan types and/or mass analysers can be taken into account when predicting a future ion current. The AGC strategy may incorporate one current prediction method or a combination of current prediction methods (which may include applying appropriate correction factors). The AGC strategy may include either or both of limiting the overall ion population and the ion population of the strongest peak.

Based on the at least one signal, an ion current prediction (or ion flux prediction) may be made. The ion current prediction may then be compared to a target ion number for one or more upcoming scans) and the injection time calculated.

Additionally or alternatively, based on the at least one signal, the expected distribution may be calculated and maximum number of charges for the expected strongest peak can be set. The injection time may be calculated such that the strongest peak does not overfill and/or the total target is not exceeded.

Table 1 lists a selection of known AGC methods and provides a brief summary of the advantages and disadvantages for predicting an ion current based thereon for DIA and DDA, and on which the selection may be based. Some of these advantages and disadvantages have been discussed in more detail above.

TABLE 1

| | AGC or Ion | | |
|---|---|---|---|
| Target | Current | | |
| Scan | Prediction | | |
| Type | Method | Advantages | Disadvantages |
| Orbital | Previous | The scan type and | Attenuation of interfering |
| trapping | orbital | analytical instrument for | multiply charged ions is an |
| mass | trapping | the previous measurement | issue. However, it is |
| analyser | mass | and the target scan are the | possible to address this |
| MS1 | analyser | same. Thus, ion | with supporting |
| | MS1 | transmission and other | information from an |
| | | conditions will be similar | electrometer, for example. |
| | | in both cases. | High resolution orbital |
| | | | trapping mass analyser |
| | | | MS1 scans are too slow to |
| | | | keep up with LC elution, |
| | | | which is relatively fast. |
| | Previous | MR-ToF measurements | An MS1 scan is relatively |
| | MR-ToF | provide high sensitivity. | time consuming, which |
| | MS1 | There is no interference for | reduces the available beam |
| | | multiply charged ions. | time. It may therefore be |
| | | Thus, additional | preferable to use a different |
| | | information from other | scan type, if available. |
| | | instruments, such as an | MR-ToF measurements can |
| | | electrometer (for example), | be easily saturated, which |
| | | is not required. | means that the results may |
| | | MR-ToF measurements can | not be an accurate |
| | | be made quickly and | representation of the |
| | | frequently. The previous | number of ions or ion |
| | | measurement may thus be | current. |
| | | recent and accordingly | The previous scan is made |
| | | provide an accurate ion | on a different (non- |
| | | current estimation | matching) analyser. Thus, |
| | | (although one or more | one or more correction |
| | | correction factors may be | factors may be required to |
| | | required to account for | account for different ion |
| | | differing ion transmissions, | transmission rates. |
| | | for example) | |
| | Orbital | The pre-scan is sufficiently | Scheduling the pre-scan to |
| | trapping | sensitive to be used for a | occur directly before the |
| | mass | subsequent MS1 scan to be | MS1 scan comes at a |
| | analyser | performed by the orbital | moderate time cost. |
| | pre-scan | trapping mass analyser. | The pre-scan also suffers |
| | (minimum | It is possible to schedule | from the interference |
| | inject | the pre-scan to occur | effects of multiply charged |
| | time, fast | directly before the MS1 | ions. However, it is |
| | scan) | scan to provide an up-to- | possible to address this |
| | | date pre-scan. | with supporting |
| | | | information from an |
| | | | electrometer, for example. |
| | Previous | A large injection time | An entire cycle of MS2 |
| | MS2 | for the MS2 scan means | scans is required to cover |
| | scan(s) | that low abundance ions | the entire mass range for |
| | | can be detected. | the MS1 scan. In other |
| | | | words, the mass ranges of |
| | | | the MS1 and MS2 are |
| | | | different (non-matching), |
| | | | so multiple MS2 scan |
| | | | results may be required. |
| | | | An MS2 scan is normally |
| | | | too slow for LC coupled |
| | | | experiments. |
| | | | The MS2 scan(s) may have |
| | | | been performed on a |
| | | | different type of analyser |
| | | | (for example, some or all of |
| | | | the MS2 scans may have |
| | | | been performed by a ToF |
| | | | analyser). Thus, one or |
| | | | more correction factors |
| | | | may be required to account |
| | | | for different transmission |
| | | | rates. |
| | | | MS2 scans only provide |
| | | | data for DIA experiments. |
| MR-ToF | Previous | A single wide m/z scan can | The m/z range of the MS1 |
| MS2 | orbital | provide information for an | scan and the MS2 scan are |
| | trapping | MS2 cycle. | distinct (non-matching), |
| | mass | | which may complicate ion |
| | analyser | | current estimation in AGC |
| | MS1 | | methods. |
| | | | The MS1 scan is performed |
| | | | on a different (non- |
| | | | matching) analyser. Thus, |
| | | | one or more correction |
| | | | factors may be required to |
| | | | account for different |
| | | | transmission rates. |
| | | | High resolution orbital |
| | | | trapping mass analyser |
| | | | MS1 scans are too slow to |
| | | | keep up with LC elution. |
| | | | The MS1 scan may not |
| | | | provide sufficient |
| | | | information for AGC, as |
| | | | the short injection time of |
| | | | the MS1 scan may not |
| | | | enable accurate |
| | | | determination of low |
| | | | intensity ions. In other |
| | | | words, there may be too |
| | | | few ions in the isolated m/z |
| | | | range for the MS2 scan. |
| | Previous | Both scans are performed | An MS1 scan is relatively |
| | MR-ToF | using the same type of | time consuming, which |
| | MS1 | analyser. This may | reduces the available beam |
| | | simplify the estimation of | time. It may therefore be |
| | | the ion current for AGC, as | preferable to use a different |
| | | correction factors may not | scan type, if available. |
| | | be required. | MR-ToF measurements can |
| | | MR-ToF measurements | be easily saturated, which |
| | | provide high sensitivity. | means that the results may |
| | | There is no interference for | not be an accurate |
| | | multiply charged ions. | representation of the |
| | | Thus, additional | number of ions or ion |
| | | information from other | current. |
| | | instruments, such as an | The previous scan is made |
| | | electrometer (for example), | on a different type of |
| | | is not required. | analyser. Thus, one or |
| | | MR-ToF measurements can | more correction factors |
| | | be made quickly and | may be required to account |
| | | frequently. The previous | for different ion |
| | | measurement may thus be | transmission rates. |
| | | recent and accordingly | |
| | | provide an accurate ion | |
| | | current estimation | |
| | | (although one or more | |
| | | correction factors may be | |
| | | required to account for | |
| | | differing ion transmissions, | |
| | | for example). | |
| | | High ions loads may be | |
| | | used if averaged. | |
| | Orbital | The pre-scan may be | The injection time of the |
| | trapping | more sensitive than a | pre-scan is too low to be |
| | mass | full MS scan using an | generally usable for an |
| | analyser | orbital trapping mass | MS2 scan. |
| | pre-scan | analyser for heavily | |
| | (minimum | multiply charged | |
| | inject | species. This is because | |
| | time, fast | the pre-scan may | |
| | scan) | measure the initial | |
| | | signal before destructive | |
| | | interference and/or gas | |
| | | collisions destroy the | |
| | | signal. | |
| | Previous | A large injection time for | The MS2 cycle time is |
| | MS2 | the MS2 scan means that | relatively long, meaning |
| | scan(s) | low abundance ions can be | that use with faster LC |
| | | detected. | coupled experiments is |
| | | | limited. |
| | | | MS2 scans only provide |
| | | | data for DIA experiments. |

It can be seen from Table 1 that some methods are more suitable than others for ion current prediction. A dedicated pre-scan (a scan with a minimum inject time to measure ion current and prevent saturation, as used in commercial orbital trapping or Orbitrap (RTM) mass analysers sold by Thermo Fisher Scientific, Inc, for example) may be useful for preventing MS1 saturation in an orbital trapping mass spectrometer. However, it may be less useful for predictions for MS2, due to the minimal sensitivity. Instead, it may be more advantageous to use a pre-scan before an MS1 injection to provide information for a scan in the MS1 domain and predict MS2 ion currents from the MS1 scan. This may be the case in commercial orbital trapping or Orbitrap (RTM) mass analysers sold by Thermo Fisher Scientific, Inc.

As discussed above, the various advantages (or disadvantages) can be balanced by constructing a scan history, which may allow an AGC strategy (or ion current estimation method) to be selected extemporaneously. In other words, stored data for each scan of one or more analytical instruments can be used to estimate an ion current according to one or more of the methods discussed above. The scans may be from different types of analytical instrument (for example, different types of hybrid or tandem mass spectrometer) or the same type of analytical instrument. That is, the stored data may be received from one or more sources.

At step 403, at least one of the one or more scans is included in a scan queue for the (ion) analytical instrument. In step 404, scans are carried out by the (ion) analytical instrument in the order specified by the scan queue. In other words, the first (ion) analytical instrument is configured according to the one or more first operating parameters and controlled based on the ion current estimated in step 402. The controlling may comprise measuring a further signal representative of the ion current obtained using the configured first (ion) analytical instrument.

When selecting a specific ion (for example, a precursor ion) or in the case of targeted selected ion monitoring (SIM), it may not be possible to only select the specific or selected ion. That is, adjacent ions may also be selected. If the specific or selected ion has a low intensity compared to its neighbours, the resulting spectra may be of lower quality. For example, there may not be enough fragments for identification and/or quantification. In such cases, it is beneficial to increase the target number of ions and the injection time, so that the peak of the ion of interest has a sufficient number of charges for identification and/or quantification. Based on the stored data, the expected distribution may be calculated, and the space charge effects may be evaluated to allow for a trade-off between overfilling traps, space charge effects, and enough ions to enable sufficient identification and quantification.

Once the scans have been performed, the output data is generated at step 405. The output data may comprise at least the further signal. The output data may be received as one or more computer files, which may include a data exchange format file (for example, a spreadsheet format, including options of a.csv or .xml file). Providing at least the further signal in a data exchange format file may enable the further signal and one or more first operating parameters to be more straightforwardly added to the stored data.

In step 406, the further signal and the one or more first operating parameters may be included in (for example, appended to) the stored data. Thus, the obtained data can be used to estimate a future ion current. Additional data as discussed above with reference to FIG. 3 (for example, detector data, full mass spectra, and so on) may also be included in the stored data. For example, step 406 may comprise appending the output data (including the further signal) and the one or more first operating parameters (if not included in the output data) to the stored data. In another example, a portion of the output data (including at least the further signal and optionally including additional data) may be extracted from the output data for inclusion in the stored data.

In some embodiments, it may be advantageous to distribute the MS1 analyses performed by the second mass analyser (ToF mass analyser 150) throughout the duration of the of the MS1 analysis performed by the first mass analyser (orbital trapping mass analyser 110). As such, in some embodiments where a plurality of MS1 analyses is performed by the second mass analyser, the MS1 analyses may be distributed evenly across the duration of the MS1 analysis performed by the first mass analyser. That is to say, the plurality of MS1 analyses to be performed by the second mass analyser may be interleaved with the MS2 analyses to be performed by the second mass analyser.

For example, FIG. 6 shows a block diagram of an analysis cycle performed by the tandem mass spectrometer 10 of FIG. 1. In the block diagram of FIG. 6, the MS1 analysis performed by the orbital trapping mass analyser 110 may have a duration of about 256 ms. FIG. 6 shows, for comparison, a profile of a chromatographic peak (elution peak) eluting from a chromatographic separation apparatus over the duration of the analysis cycle. It will be appreciated that the MS1 analysis performed by the orbital trapping mass analyser typically takes a sample of ions from the beginning of the elution of the chromatographic peak. As such, for relatively fast eluting chromatographic peaks, it is possible that the MS1 analyses performed by the orbital trapping mass analyser may not fully characterise the chromatographic peak. For example, in FIG. 6, only two or three MS1 analyses may be performed by the orbital trapping mass analyser 110 over the duration of the relatively fast eluting chromatographic peak.

To improve the characterisation of the chromatographic peak, as illustrated in FIG. 6, a plurality of MS1 analyses (which may be referred to as “fluxscans” herein) may be performed by the ToF mass analyser 150 concurrently with the MS1 analysis performed by the orbital trapping mass analyser 110. In particular, the plurality of MS1 analyses performed by the ToF mass analyser 150 may be interleaved with the plurality of MS2 analyses performed by the ToF mass analyser. MS1 scans by the ToF mass analyser 150 are able to be carried out frequently and at relatively low time overhead. The ToF MS1 scans, which preferably incorporate a full ion load (which may be 30,000 ions or more), can provide more accurate ion current information than the orbital trapping mass analyser scans, but with their frequency, can also bridge the gap between the slower orbital trapping mass analyser MS1 scans and the fast LC cycle times. They can thus be used to inform both orbital trapping MS1 scans and ToF MS2 accumulation times.

In the embodiment of FIG. 6, at least 5 MS1 analyses are performed over the duration of a single MS1 analysis performed by the orbital trapping mass analyser 110. It will be appreciated that more or fewer MS1 analyses may be performed over the duration of the single MS1 analysis.

In the embodiment of FIG. 6, the plurality of MS1 analyses may be interleaved with the MS2 analyses by performing an MS1 analysis followed by a predefined number of MS2 analyses. For example, an MS1 analysis may be repeated after every 5, 10, 15, or 20 MS2 analyses performed by the ToF mass analyser 150. As such, the analyses performed in the MS1 domain may be interleaved evenly throughout the duration of the analysis performed in the MS1 domain by the first mass analyser. In another example, the fluxscans may be inserted with a pre-determined frequency. For example, the plurality of MS1 analyses may be inserted at a frequency of 5, 10, 15 or 20 Hz or more into batches of MS2 acquisitions (which may occur at a frequency of 200 Hz, for example). Alternatively, the MS1 analyses may be performed at predetermined time intervals during the MS1 analysis performed by the orbital trapping mass analyser 110. Whichever interleaving method is used, the fluxscans are preferably made with a cadence that generates multiple points along the width of the LC peak. Thus, each fluxscan may be used to more accurately regulate the next scan(s). Modelling or machine learning may be used to predict the peak shape to select an interleaving frequency and better prevent overload of ions.

It will be appreciated that in the embodiment of FIG. 6, each of the MS1 analyses performed by the ToF mass analyser 150 is performed across the entire m/z range of interest. In other embodiments, MS1 analyses may be performed across m/z subranges of interest, where the analyses are interleaved throughout the duration of the MS1 analysis performed by the orbital trapping mass analyser. In some embodiments, each MS1 analysis of a m/z subrange of interest may be repeated a plurality of times throughout the duration of the MS1 analysis performed by the orbital trapping mass analyser 110. Some of the plurality of MS1 analyses may be averaged, which may improve the dynamic range.

In some embodiments, the data from the MS1 analyses performed by the first and second mass analysers may be used to identify a chromatographic peak eluting from the chromatographic separation apparatus. For example, the data from the MS1 analyses performed by the ToF mass analyser 150 may be used to identify and/or characterise the chromatographic peak shown in FIG. 6. In some embodiments, the analyses to be performed by in the MS2 domain by the ToF mass analyser 150 may be selected based on the identified chromatographic peak eluting from the mass spectrometer. For example, the combined list of precursor ion peaks may be updated based on the chromatographic peak identified. In particular, the order of precursor ions to be analysed in the MS2 domain on the combined list of precursor ion peaks may be updated based on the identified chromatographic peak.

In some embodiments, the chromatographic peak apex (maximum) may be used to time the performance of the analyses in the MS2 domain by the ToF mass analyser 105. For instance, it may be beneficial to perform an MS2 measurement at or near the apex of an elution peak in DDA methods, since this may correspond to a larger number of ions. Thus, performing the MS2 measurement at or near the apex may minimise the beam time required per precursor. This may result in a more efficient analytical instrument.

MS2 scans are normally performed in cycles in DDA and each cycle may have a time duration between around 0.2 to 1 second. However, an injection during an MS2 analysis may occur at a time within the cycle that yields insufficient ions. This may result in wasted beam time and this wasted beam time may be replicated in each cycle.

According to the present disclosure, an analysis (for example, one or more of the analyses in the MS2 domain performed by the ToF mass analyser 150) may be scheduled to occur at a particular time, based on the stored data. The scheduling may be achieved by determining a scheduled injection time for ions into an analyser.

For example, the stored data may be used to track a chromatographic peak formation. In one example, a peak shape may be modelled based on the data from the MS1 analyses performed by the ToF analyser 150 (or any previous analyses that allow determination of the peak shape). The modelling may be improved by combining the data from the MS1 analyses by the ToF analyser 150 with an absolute signal based on a prior MS2 scan or an MS1 scan. In another example, information relating to a previous (for example, a same or similar) chromatographic peak may be used to model a peak shape. The information may include data from previous MS1 analyses performed by a ToF analyser. A similar peak may be a peak having the same peak shape, peak height, or otherwise being comparable to another peak.

Based on the modelled peak shape, an injection time (a point in time at which ion injection should occur) may be determined to schedule an analysis or the ion injection to coincide (to within a threshold tolerance) with the chromatographic peak apex. In other words, an analysis (for example, a precursor scan) may be delayed until the peak apex is reached. In a further example, the data from the MS1 analyses by the ToF analyser and/or information relating to a previous peak may be used to determine an injection time without modelling a chromatographic peak shape. For instance, if the width of the peak is known or can be determined (for example, based on the stored data), the acquisition may be delayed from the point of detection by approximately half the peak width. More than one data source may be combined to determine an injection time that is expected to coincide with the peak.

The scanned data may thus enable injection to occur at a time when sufficient ions may be yielded. This may improve the results obtained by an analytical instrument. For example, improved quantitation and/or ion analysis may be enabled. Furthermore, the injection time can be determined based on real time chromatographic peak elution data. This may be useful for unknown samples (in which expected retention times may not be known) or complex chromatographic peaks.

In another example, although the apex of the peak has already occurred or is not due for an amount of time, the stored data may indicate that sufficient ions would be yielded at a certain time. An injection time may thus be determined such that the injection is scheduled to avoid coinciding with the chromatographic peak. In other words, a precursor scan may not be delayed until the peak apex is reached, but may occur at another time. This may avoid or reduce wasted experiment time, as the injection may be scheduled to occur earlier than otherwise would be the case when sufficient ions would be present regardless.

In a further example, the stored data may indicate that the peak apex has already occurred and that injection is unlikely to yield sufficient ions. An injection time may therefore be determined to delay a precursor scan until a next chromatographic peak apex. This may prevent a wasted spectrum, where insufficient ions are present to generate sufficient information for quantitation, for instance. Furthermore, as described above, since the injection time may be determined to coincide with the next peak apex based on the stored data, the scan may more accurately coincide with the next peak apex than would be the case without use of the stored data.

In another example, where the stored data indicates that injection is unlikely to yield sufficient ions, an m/z range or scan may be excluded entirely.

In yet a further example, an analysis (for example, one or more analyses of the analyses in the MS2 domain performed by the ToF mass analyser 150) may be scheduled to occur distal from the apex of a chromatographic peak (for example, at a peak minimum). For instance, an undesired peak may obscure a target material peak. It may therefore be useful to schedule an MS2 measurement away from the undesired peak apex to reduce the signal of the undesired peak in the analytical results.

Although chromatographic peak maxima and minima estimations have been described above mostly with reference to MS2 scans, it will be appreciated that estimation of a chromatographic peak maximum and/or minimum may be applied equally to MS1 scans and that this may provide the same or similar advantages.

Similarly, although the peak maxima and minima estimations have been described above with reference to a chromatographic peak, it will be appreciated that a different type of peak maximum and/or minimum may be estimated. For example, an analytical instrument may comprise an ion mobility analyser and a time-of-flight mass analyser. In this example, a plurality of MS1 and/or MS2 analyses may be performed by the time-of-flight mass analyser to characterise an ion mobility peak. It will be understood that other examples of peak maxima and minima estimations are also possible.

As the resolution of the MS1 ToF scans may be far higher than any other fast scanning method (for example, orbital trapping mass analyser or ion trap pre-scans), it may be easier to determine which ion species are over- or underloaded. Thus, the interleaved MS1 scans may be very advantageous for ion current prediction.

The data from the MS1 analyses may also be used for other purposes. For example, the data may be used for improved quantitation of detected analytes, or combined with the higher resolution orbital trapping MS1 data in other ways.

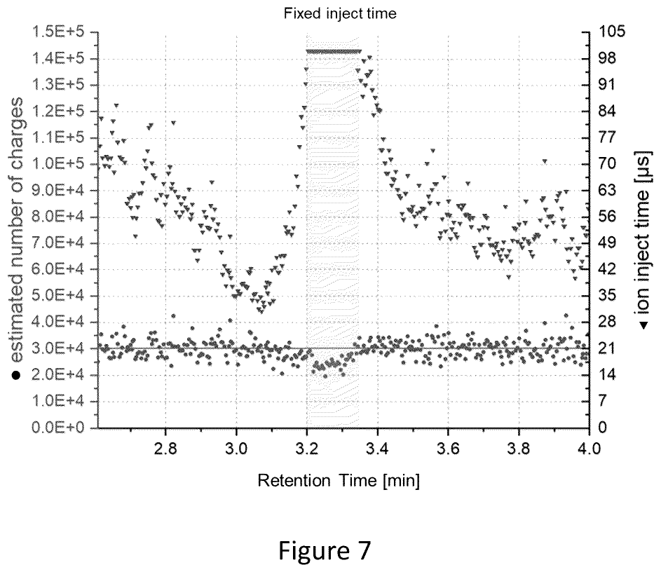

FIG. 7 illustrates a graph showing a number of charges per shot being regulated based on control of an ion accumulation time over a period of a sample LC elution and the resultant stable ion current. The graph was obtained when implementing an LC-MS DIA method with the tandem mass spectrometer 10 illustrated in FIG. 1 using a human plasma protein sample. A plurality of MR-ToF full-MS scans (fluxscans) were run several times per second, with a target of 3×10⁴ charges per shot (as illustrated by the horizontal line on the graph).

Since the ion flux changes with the LC elution, the calculated ion injection time shifts to maintain the target number of ions, which is shown by the upper set of results in FIG. 7. The ion injection time in FIG. 7 reaches a pre-set maximum retention time (RT), in this case, 3.2 minutes. However, another maximum RT may be set. As can be seen in FIG. 7, the overall number of charges per shot remains relatively stable, with the exception of the point where the ion inject time limit was reached.

In FIG. 7, the rate of the plurality of full-MS scans is faster than the change in signal due to the LC elution. A moving average may therefore be used to reduce jitter in the measurements. The high repetition rate of the full-MS scans also means that the ion inject time is self-regulating. That is, the previous full-MS scan(s) alone are sufficient to enable a determination of the ion accumulation time for the next full-MS scan. This is advantageous, as it removes the need to perform low sensitivity pre-scans, or infer an ion current from a non-matching scan type.

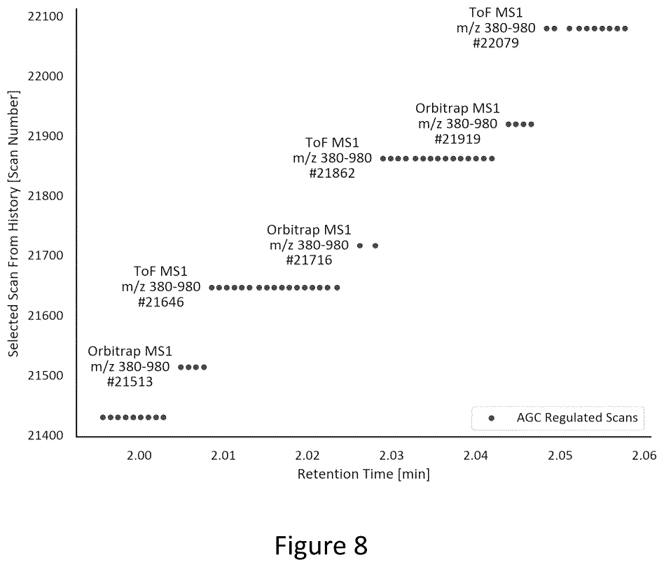

FIG. 8 illustrates an example of AGC regulated scans selecting different scan types from the stored data (scan history) during method execution to determine an ion current. In this example, a series of MS2 scans, orbital trapping MS1 scans and a plurality of ToF MS1 scans (fluxscans) have been made and data thereof is stored in the scan history. The y-axis shows which scan was used to make the AGC calculation, whilst the x-axis shows the retention time. It can be seen from FIG. 8 that most scans are regulated by the plurality of ToF MS1 scans. Occasionally though, an orbital trapping MS1 scan is more recent and determined by the controller to be more suitable.

In the example shown in FIG. 8, the plurality of ToF MS1 scans are performed with a frequency such that the previous MS2 cycle is never used for AGC regulation. However, it is possible that the MS2 scan may be selected as being more suitable in some cases. For example, the intensity of the ions may be low enough that the plurality of ToF MS1 scans and/or orbital trapping MS1 scan provides too little signal.

In some embodiments, it may be advantageous to use a first operation mode to determine an ion current (or equivalently, ion flux) for estimating an ion current (ion flux) of a second, different operation mode. The second operation mode may be an operation mode of the same (type of) component as for the first operation mode. The first operation mode may have certain advantages (for example, being higher resolution, less likely to saturate an upstream device, and so on). The component can thus be operated to benefit from these advantages, whilst also enabling an accurate ion current estimation for the second mode, as the same (type of) component may produce similar ion currents.

For instance, as discussed above, an MR-ToF may operate in a single reflection mode, whereby ions take a short (for example, 1m) path to a detector. This may reduce the resolving power of the MR-ToF, but may be very fast and provide high transmission, with few ion losses due to focusing errors or collision with background gas. It may therefore be advantageous for ion population measurement to use this single turn mode for current measurement. This may prevent saturation of an extraction trap or another upstream devices. Furthermore, the single turn mode may be useful for species that are liable to be scatter with background gas such as, for example, large ions, intact proteins and so on. Therefore, a first ion current (ion flux) measurement may be made in this first mode of operation.

The first ion current (ion flux) measurement may then be used to estimate an ion current (ion flux) for a second mode of operation of the MR-ToF. The second mode of operation may be a multi-turn mode or zoom mode, for example, which may be higher resolution modes of operation.

In another example, the first mode of operation may be a zoom mode of operation. The zoom mode may result in a broader detected peak, which may correspond to a higher dynamic range. Thus, the zoom mode may be useful for current measurement of intense species. The second mode of operation may then be a multi-turn mode or a single turn mode, for example.

The first operation mode and second operation modes need not be operation modes of the same (type of) component. For example, one component may have a (sufficiently) similar operation mode to another component. The first operation mode may thus still be used to estimate an ion current (or equivalently, ion flux) for a second, different operation mode. For instance, a reflectron may have an operation mode similar to the MR-ToF single reflection mode and this operation mode may be used to estimate an ion current in the MR-ToF mode (or vice versa).

As discussed herein, measurements (for example, ion current measurements) may be made on an analytical and the data stored for experiments or samples run on another analytical instrument. The other analytical instrument may be the same type or a different type of analytical instrument. The stored data may be absolute or relative data. The stored data may be combined with data gained during the experiments or samples run on the other analytical instrument. The stored data may be updated by a machine learning model.

Many scan parameters may cause variation in ion transmission or detected ion signals and may be compensated for. These include, for instance, fragmentation method (if any), collision energy, scanning m/z range, isolation window, ion guide RF and DC potentials, ion path, analyser choice, and so on.

The present disclosure has been primarily described in the context of a hybrid mass spectrometer incorporating an orbital trapping mass analyser and a time-of-flight analyser. However, the methods described herein may be incorporated in any other suitable analytical instrument. The methods may be particularly useful for implementation in mass spectrometers, including orbital trapping mass spectrometers and hybrid mass spectrometers incorporating an orbital trapping mass analyser and an ion trap. Furthermore, analysers without accumulating traps (for example, triple quadrupoles and orthogonal ToF analysers) may benefit from beam attenuation, or a variation in acquisition time based on current prediction, as may be implemented using any known method.

It will be appreciated that discussions in respect of an ion current may apply equally to ion flux measurements, as ion flux measurements may be proportional to ion current measurements. It will therefore also be understood that references to an ion current and/or references to an ion flux may be described generally as referring to an ion current (ion flux) parameter.

The methods described herein may be implemented with computer system configurations including hand-held devices, microprocessor systems, microprocessor-based or programmable consumer electronics, minicomputers, mainframe computers and the like. The embodiments can also be practiced in distributed computing environments, where tasks are performed by remote processing devices that are linked through a network.

The computer system may include a processor, such as a central processing unit (CPU). The processor may execute logic in the form of a software program. The computer system may include a memory including volatile and non-volatile storage medium. The different parts of the system may be connected using a network (for example, wireless networks and wired networks). The computer system may include one or more interfaces. The computer may contain a suitable operating system such as UNIX (including Linux) or Windows (RTM), for example.

Certain embodiments can also be embodied as computer-readable code on a non-transitory computer-readable medium. The computer readable medium may be any data storage device than can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion. Although embodiments according to the disclosure have been described with reference to particular types of devices and applications (particularly mass spectrometers) and the embodiments have particular advantages in such case, as discussed herein, approaches according to the disclosure may be applied to other types of device and/or application. The specific calibration details of the (ion) analytical instrument, whilst potentially advantageous (especially in view of known calibration constraints and capabilities), may be varied significantly to arrive at devices with similar or identical operation. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

It will be appreciated that there is an implied “about” prior to temperatures, concentrations, times, pressures, flow rates, cross-sectional areas, voltages, currents, etc. discussed in the present teachings, such that slight and insubstantial deviations are within the scope of the present teachings. Furthermore, values referred to as being “equal” may in fact differ by less than a threshold amount. The threshold amount may be 5%, for example. The threshold may also be greater than 5% (for instance, 10%, 20% or 50%) or less than 5% (for example, 2% or 1%), depending on the context. The threshold amount need not be expressed as a percentage, and may instead be an absolute value. The absolute value may depend on the context.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an electrode) means “one or more” (for instance, one or more electrodes).

Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B” is true, or both “A” and “B” are true. Furthermore, the use of bracketed terms (terms in parentheses) is inclusive, such that the phrase (C) D″ is true when “D” is true, or both “C” and “D” are true. For example, the term “(ion) analytical instrument” may mean “ion analytical instrument” or “analytical instrument”.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the invention. That is, an element termed a “first” element (for example, a first (ion) analytical instrument) may instead be termed a “second” element (for example, a second (ion) analytical instrument) and an element termed a “second” element (for example, a second (ion) analytical instrument) may instead be considered a “first” element (for example, a first (ion) analytical instrument).

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

All literature and similar materials cited in this application, including but not limited to patents, patent applications, articles, books, treaties and internet web pages are expressly incorporated by reference in their entirety for any purpose. Unless otherwise described, all technical and scientific terms used herein have a meaning as is commonly understood by one of ordinary skill in the art to which the various embodiments described herein belongs.

1. A method of controlling a first analytical instrument, the method comprising:
configuring the first analytical instrument to be controlled according to one or more first operating parameters; and
controlling the configured first analytical instrument based on an estimated ion current, wherein the ion current is estimated by:
selecting at least one signal from stored data comprising a plurality of signals and a respective one or more second operating parameters associated with each of the plurality of signals, wherein each signal of the plurality of signals is representative of an ion current obtained using the first analytical instrument configured according to the respective associated one or more second operating parameters or using a second analytical instrument configured according to the respective associated one or more second operating parameters, and wherein the at least one signal is selected based on the one or more first operating parameters; and
using the at least one selected signal to estimate the ion current.

2. The method of claim 1, wherein the first analytical instrument comprises an ion trap, wherein the method further comprises accumulating a batch of ions in the ion trap, and wherein controlling the configured first analytical instrument based on the estimated ion current comprises regulating a number of ions in the batch of ions accumulated in the ion trap based on the estimated ion current, wherein regulating the number of ions preferably comprises controlling a fill time of the ions into the ion trap.

3. The method of claim 1, further comprising analysing ions during a time period, and wherein controlling the configured first analytical instrument based on the estimated ion current comprises regulating a duration of the time period based on the estimated ion current; and/or
wherein controlling the configured first analytical instrument based on the estimated ion current comprises adjusting, based on the estimated ion current, a target number of ions, an ion accumulation time and/or a mass-to-charge ratio (m/z) range.

4. The method of claim 1, wherein the one or more first and/or second operating parameters comprise one or more of: an operation mode; an m/z range; an isolation window width; a target number of ions; at least one parameter for implementing a fragmentation method and/or information regarding a fragmentation method; a fragmentation energy; and an ion path through the first and/or respective second analytical instrument; and/or
wherein the one or more first and/or second operating parameters comprise one or more component operating parameters of at least one component of the respective first and/or second analytical instrument, wherein the at least one component preferably comprises one or more of: a mass analyser; an ion guide; an ion gate; a mass filter; a fragmentation cell; an ion source; an ion trap; and a detector; and/or
wherein the one or more first and/or second operating parameters comprise a type of scan, wherein the type of scan preferably comprises an MS1 or an MS2 scan; and/or wherein the one or more first and/or second operating parameters comprises a mass filter isolation window width and/or isolation window centre m/z value; and/or
wherein the one or more first and/or second operating parameters comprise a type of mass analyser, preferably wherein the type of mass analyser comprises a Fourier Transform mass analyser, preferably an orbital trapping mass analyser, or a time-of-flight (ToF) mass analyser.

5. The method of claim 4 when the one or more first and/or second operating parameters comprise a target number of ions, wherein the target number of ions is a target number of ions to be accumulated in an ion trap and/or a target number of ions in a peak detected when controlling the first analytical instrument.

6. The method of claim 4, wherein the operation mode comprises a component operation mode and/or the one or more component operating parameters comprise an amplitude and/or frequency of one or more RF and/or DC potentials applied to the at least one component.

7. The method of claim 6, wherein the operation mode comprises a component operation mode, wherein the first analytical instrument and the analytical instrument using which the at least one signal was obtained comprise the at least one component and the component operation mode of the first analytical instrument and the component operation mode of the analytical instrument using which the at least one signal was obtained are different.

8. The method of claim 1, wherein the first and/or second analytical instrument comprises a multi-reflection time-of-flight (MR-ToF) mass analyser and wherein the one or more first and/or second operating parameters comprise an MR-ToF mass analyser mode of operation,
preferably wherein the MR-ToF mass analyser mode of operation comprises a single oscillation mode, in which ions are caused to make a single oscillation in a first direction between ion mirrors spaced apart and opposing each other in the first direction, or a multiple cycle mode, in which ions are caused to perform multiple cycles of a plurality of oscillations in the first direction between the ion mirrors by using a deflector to reverse a drift velocity direction of the ions one or more times after an initial cycle.

9. The method of claim 1, wherein the first and/or second analytical instrument comprises a detector, wherein the one or more first and/or second operating parameters comprise a type of detector, preferably wherein the type of detector comprises a liquid chromatography (LC) detector and/or an electrometer.

10. The method of claim 1, wherein the selecting comprises applying one or more filtering criteria to the stored data to obtain a subset of data, the subset of data comprising the at least one signal and its respective associated one or more second operating parameters; and/or the selecting comprises using an algorithm, a graph, a mathematical model, or a machine learning model to select the at least one signal.

11. The method of claim 10 when the selecting comprises applying one or more filtering criteria to the stored data, wherein the one or more filtering criteria comprises at least one of the one or more first operating parameters and at least one of the respective one or more second operating parameters being the same, sufficiently similar or most similar; and/or wherein the one or more filtering criteria are based on one or more of: at least one of the one or more first operating parameters, at least one of the respective one or more second operating parameters, a number of detected ions, a time duration since obtaining a signal of the plurality of signals, a retention time duration, an underfill indication and an overfill indication.

12. The method of claim 11, wherein the one or more filtering criteria comprises one or more of: the number of detected ions being greater or less than a threshold number of detected ions, a target number of ions being within a threshold tolerance of the detected number of ions, a time duration since obtaining the at least one signal being less than a threshold time duration, and a retention time duration being less than a threshold retention time duration.

13. The method of claim 1, wherein the controlling comprises measuring a further signal representative of the ion current and, subsequent to the controlling, including the further signal and the one or more first operating parameters in the stored data.

14. The method of claim 1, wherein the at least one signal comprises more than one signal and the estimating further comprises weighting the more than one signals to estimate the ion current.

15. The method of claim 1, wherein the stored data further comprises, for one or more of the plurality of signals, one or more of: scan data, pre-scan data, one or more electrometer measurements, LC detector data, and data from one or more previous experiments,
wherein the scan data preferably comprises one or more of: one or more acquired mass spectra, information regarding one or more detected peaks, an m/z range and ion accumulation time,
wherein the information regarding the one or more detected peaks optionally comprises an intensity and/or resolution of the peaks.

16. The method of claim 1, wherein the first analytical instrument comprises a first mass analyser, preferably an orbital trapping mass analyser, and a second mass analyser, preferably an MR-ToF mass analyser.

17. The method of claim 16, wherein controlling the first analytical instrument comprises performing a plurality of analysis cycles, wherein each cycle comprises:
performing a single analysis across an m/z range in an MS1 domain using the first mass analyser; and
performing a plurality of analyses across the m/z range in the MS1 domain using the second mass analyser; and
performing analyses of precursor ions in an MS2 domain using the second mass analyser.

18. The method of claim 17, wherein performing the plurality of analyses in the MS1 domain by the second mass analyser comprises subdividing the m/z range into a plurality of m/z subranges and performing an analysis across each m/z subrange in the MS1 domain using the second mass analyser; and/or
wherein the analyses performed in the MS1 and MS2 domains by the second mass analyser are performed concurrently with the single analysis in the MS1 domain performed by the first mass analyser; and/or
wherein the plurality of analyses performed in the MS1 domain by the second mass analyser are interleaved with the analyses performed in the MS2 domain by the second mass analyser.

19. The method according to claim 17 when dependent on claim 13, wherein the further signal representative of the ion current comprises one or more signals obtained from the plurality of analyses that are representative of the ion current.

20. The method according to claim 1, further comprising, in response to receiving additional data after a storage threshold of the stored data is reached, deleting or overwriting one or more data entries in the stored data to include the additional data in the stored data, wherein the storage threshold preferably corresponds to a maximum number of data entries and/or a maximum storage capacity.

21. The method of claim 20, wherein the stored data comprises a set of editable data and a set of non-editable data and the deleting or overwriting comprises deleting one or more data entries in the set of editable data.

22. The method of claim 21, wherein data is stored as non-editable data based on one or more of: a type of scan from which the data was obtained, an expected performance frequency of the type of scan, and a time duration since the type of scan was last performed, wherein preferably the data is stored as non-editable data based on the expected performance frequency being less than a threshold frequency and/or the time duration being more than a threshold time duration.

23. A controller configured to:
configure a first analytical instrument to be controlled according to one or more first operating parameters; and
control the configured first analytical instrument based on an estimated ion current, wherein the ion current is estimated by:
selecting at least one signal from stored data comprising a plurality of signals and a respective one or more second operating parameters associated with each of the plurality of signals, wherein each signal of the plurality of signals is representative of an ion current obtained using the first analytical instrument configured according to the respective associated one or more second operating parameters or using a second analytical instrument configured according to the respective associated one or more second operating parameters, and wherein the at least one signal is selected based on the one or more first operating parameters; and
using the at least one selected signal to estimate the ion current.

24. A computer program comprising instructions which, when executed by a computer, cause the computer to:
configure a first analytical instrument to be controlled according to one or more first operating parameters; and
control the configured first analytical instrument based on an estimated ion current, wherein the ion current is estimated by:
selecting at least one signal from stored data comprising a plurality of signals and a respective one or more second operating parameters associated with each of the plurality of signals, wherein each signal of the plurality of signals is representative of an ion current obtained using first configured according to the respective associated one or more second operating parameters or using a second analytical instrument configured according to the respective associated one or more second operating parameters, and wherein the at least one signal is selected based on the one or more first operating parameters; and
using the at least one selected signal to estimate the ion current.

25. A system comprising a first analytical instrument, the controller of claim 23 and a database in communication with the first analytical instrument, the database comprising stored data.
